(19) United States
(12) Patent Application Publication
(10) Pub. No.: US 2025/0272042 A1
(43) Pub. Date: Aug. 28, 2025

(54) TECHNIQUES FOR COORDINATING THE DISPLAY OF INFORMATION BETWEEN A PLURALITY OF ELECTRONIC DEVICES, AND SYSTEMS AND METHODS OF USE THEREOF

(71) Applicant: Meta Platforms Technologies, LLC, Menlo Park, CA (US)

(72) Inventor: Dan Kun-yi Chen, Seattle, WA (US)

(21) Appl. No.: 19/044,513

(22) Filed: Feb. 3, 2025

Related U.S. Application Data
(60) Provisional application No. 63/556,809, filed on Feb. 22, 2024.

(51) Int. Cl. G06F 3/14; G02B 27/01; G06F 3/01

(52) U.S. Cl. CPC G06F 3/1423; G02B 27/0172; G02B 27/0179; G06F 3/013; G02B 2027/0178

(57) ABSTRACT

A method for seamless display switching includes a head-wearable device at head-wearable device and one or more display devices is described. The method includes causing the head-wearable device to display a user interface. The method further includes, in accordance with a determination, at a first point in time, that the user is looking at a first display device of the one or more display devices: (i) causing the head-wearable device to cease displaying the user interface and (ii) causing the first display device to display the user interface. The method further includes, in accordance with a determination, at a second point in time after the first point in time, that the user is not looking at the one or more displays devices: (i) causing the first display device to cease displaying the user interface and (ii) causing the head-wearable device to display the user interface.

### CROSS-REFERENCE TO RELATED APPLICATIONS

This application claims priority to U.S. Prov. Patent App. No. 63/556,809, filed Feb. 22, 2024, entitled “Techniques for Coordinating the Display of Information Between a Plurality of Electronic Devices, and Systems and Methods of Use Thereof,” which is hereby fully incorporated by reference in its entirety.

### TECHNICAL FIELD

This relates generally to techniques coordinating the display of information between a plurality of electronic devices, including a head-wearable extended-reality (XR) device. The techniques include, but are not limited to, displaying the information (e.g., a user interface) on a first electronic device (e.g., the head-wearable XR device), and then displaying the information on another electronic device (e.g., a television) such that the information appears to seamlessly switch between the plurality of electronic devices.

### BACKGROUND

Users often carry several electronic devices (e.g., a smartphone, a smartwatch, an extended-reality headset, a tablet, etc.) and/or have several other electronic devices in their home (e.g., a laptop, a television, a personal computer, etc.) at the same time. It can be burdensome and time-consuming for users to switch between different devices while continuously displaying the same information. Thus, there is a need for techniques that allow for a user to seamlessly transition between devices.

As such, there is a need to address one or more of the above-identified challenges. A brief summary of solutions to the issues noted above are described below.

### SUMMARY

The methods, systems, and devices described herein allows users of a plurality of electronic devices to seamlessly transition information between respective displays of the plurality of electronic devices. By coordinating the plurality of electronic devices with at least one computing device, information can be handed off between different interfaces in a way that appears to be seamless to a user.

One example of an extended-reality (XR) system is described herein. This example XR system includes a head-wearable device, that includes one or more sensors and is configured to be worn by a user, one or more display devices (e.g., a wrist-wearable device, computer, a smart television, a smartphone, etc.), and a non-transitory computer readable storage medium including executable instructions that, when executed by a computing device, cause the computing device to perform actions while a head-wearable device, worn by a user, is communicatively coupled to one or more display devices. The instructions cause the computing device to cause the head-wearable device to display a user interface. The instructions further cause the computing device to, in accordance with a determination, at a first point in time, that the user is looking at a first display device of the one or more display devices: (i) cause the head-wearable device to cease displaying the user interface and (ii) cause the first display device to display the user interface. The instructions further cause the computing device to, in accordance with a determination, at a second point in time after the first point in time, that the user is not looking at the one or more displays devices: (i) cause the first display device to cease displaying the user interface and (ii) cause the head-wearable device to display the user interface.

Having summarized the first aspect generally related to use of an XR system for seamless display switching above, the second aspect of an XR system for manually-controlled display switching is described. In another example of an XR system, the XR system includes a head-wearable device, a wrist-wearable device, which is communicatively coupled to the head-wearable device, and a non-transitory computer readable storage medium includes executable instructions that, when executed by a computing, cause the computing device to perform actions while a head-wearable device, worn by a user, is communicatively coupled to one or more display devices. The instructions cause a first display device of the one or more display devices to display a user interface. The instructions further cause the computing device to, in response to a switch input, performed by the user and detected at the head-wearable device: (i) cause the first display device to cease displaying the user interface and (ii) cause a second display device to display the user interface. The switch input indicates the second display device of the one or more display devices.

Having summarized the second aspect generally related to use of an XR system for seamless display switching above, the third aspect of an XR system for changing cameras while in an ongoing video call is now summarized. In an additional example of an XR system, the XR system includes a head-wearable device, a wrist-wearable device, which is communicatively coupled to the head-wearable device, and a non-transitory computer readable storage medium that includes instructions. The head-wearable device includes a first sensor (e.g., an eye-tracking camera and/or an IMU) and a first imaging device, and the wrist-wearable device includes a second sensor (e.g., an IMU and/or an EMG sensor) and a second imaging device. The instructions, when executed by a computing device, while the head-wearable device and the wrist-wearable device are worn by a use, and while a video call is being performed between the user and at least one other user, cause the computing device to cause the first imaging device of the head-wearable device to capture first image data (e.g., video and audio data) to be used during the video call. The instructions further cause the computing device to receive first sensor data (e.g., the user looks at the watch to use a camera on the watch in selfie mode) from the first sensor of the head-wearable device and second data (e.g., the user lifts the wrist-wearable device to use the camera on the watch in selfie mode) from the second sensor of the wrist-wearable device. The instructions further cause the computing device to compare the first sensor data and the second sensor data. In accordance with a determination that the comparison of the first sensor data and the sensor data indicates that the user is not looking at the wrist-wearable device, the instructions further cause the computing device to cause the first imaging device to continue to capture the first image data to be used during the video call. In accordance with a determination that the comparison of the first sensor data and the sensor data indicates that the user is looking at the wrist-wearable device, the instructions further cause the computing device to cause the second imaging device to capture second image data to be used during the video call.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1M illustrate an example sequence of an extended-reality (XR) system for seamlessly switching a user interface (UI) between a plurality of displays, in accordance with some embodiments.

FIGS. 2A-2F illustrate an example sequence of an XR system for switching between cameras for capturing image data for a video call, in accordance with some embodiments.

FIGS. 3A and 3B illustrate example artificial-reality systems, in accordance with some embodiments.

FIGS. 4A and 4B illustrate an example wrist-wearable device 400, in accordance with some embodiments.

FIGS. 5A-5C illustrate example head-wearable devices, in accordance with some embodiments.

FIGS. 6A and 6B illustrate an example handheld intermediary processing device, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with various types or embodiments of artificial-reality systems. Artificial-reality (AR), as described herein, is any superimposed functionality and or sensory-detectable presentation provided by an artificial-reality system within a user's physical surroundings. Such artificial-realities can include and/or represent virtual reality (VR), augmented reality, mixed artificial-reality (MAR), or some combination and/or variation one of these. For example, a user can perform a swiping in-air hand gesture to cause a song to be skipped by a song-providing API providing playback at, for example, a home speaker. An AR environment, as described herein, includes, but is not limited to, VR environments (including non-immersive, semi-immersive, and fully immersive VR environments); augmented-reality environments (including marker-based augmented-reality environments, markerless augmented-reality environments, location-based augmented-reality environments, and projection-based augmented-reality environments); hybrid reality; and other types of mixed-reality environments.

Artificial-reality content can include completely generated content or generated content combined with captured (e.g., real-world) content. The artificial-reality content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create content in an artificial reality and/or are otherwise used in (e.g., to perform activities in) an artificial reality.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMU) s of a wrist-wearable device) and/or detected via image data captured by an imaging device of a wearable device (e.g., a camera of a head-wearable device)) or a combination of the user's hands. In-air means, in some embodiments, that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single or double finger tap on a table, on a user's hand or another finger, on the user's leg, a couch, a steering wheel, etc.). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight (ToF) sensors, sensors of an inertial measurement unit, etc.) detected by a wearable device worn by the user and/or other electronic devices in the user's possession (e.g., smartphones, laptops, imaging devices, intermediary devices, and/or other devices described herein).

As described herein, seamlessly switching information (e.g., a user interface) between respective displays of a plurality of electronic devices (e.g., including a head-wearable device including at least one display) describes how a user perceives the information from their point-of-view. The information appears to move between the respective displays such as if the information were a real-world object travelling in real-space.

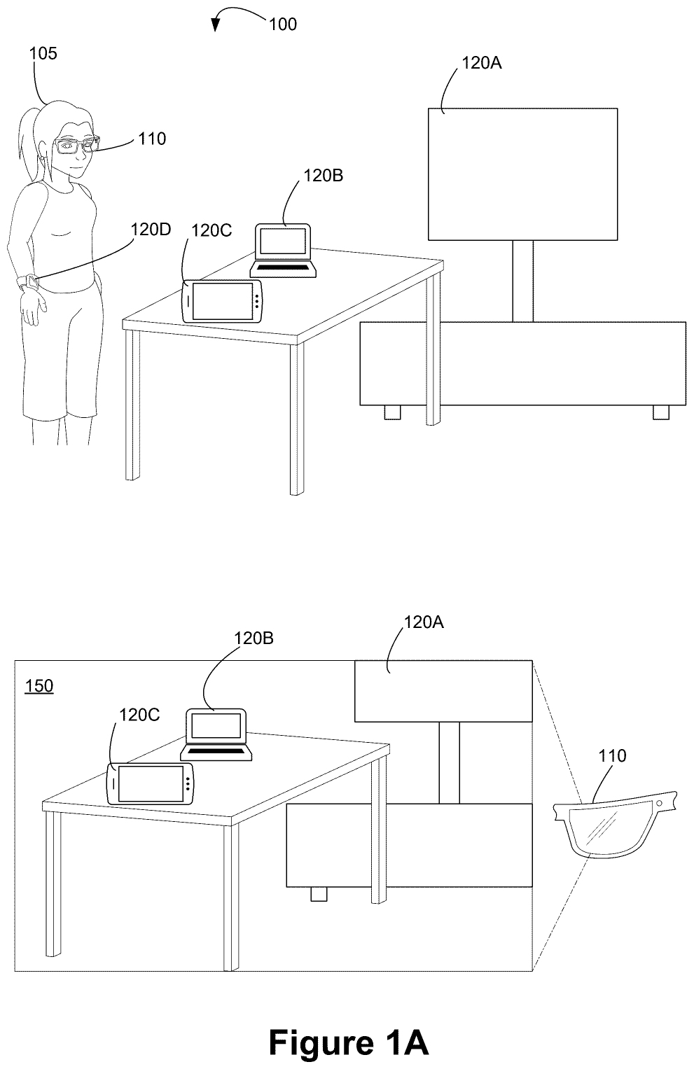

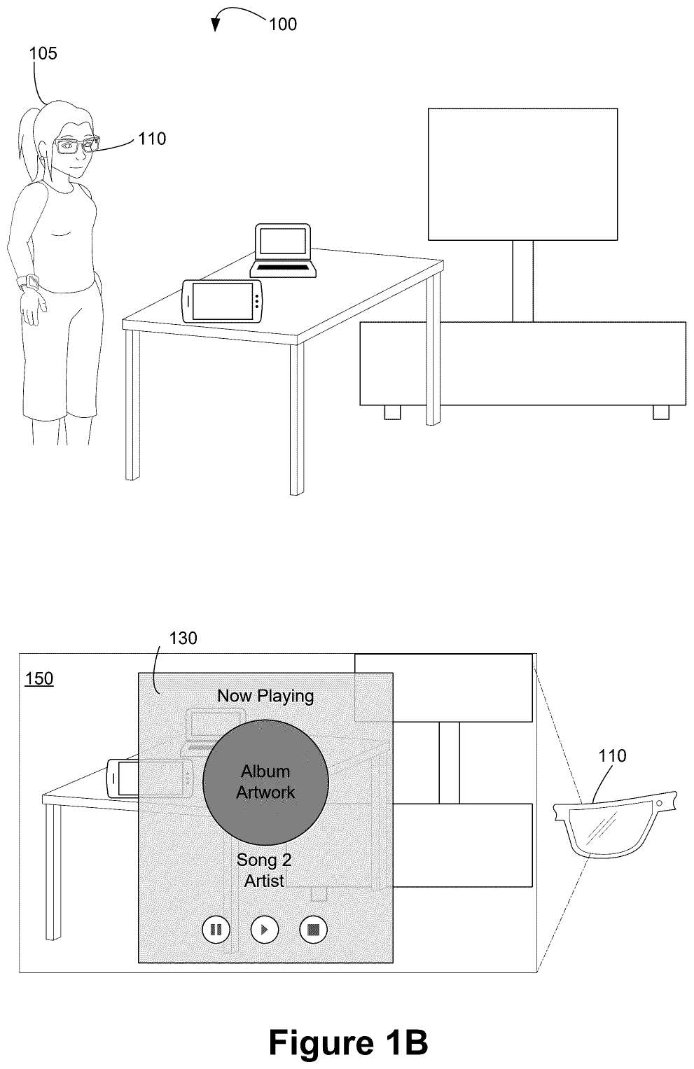

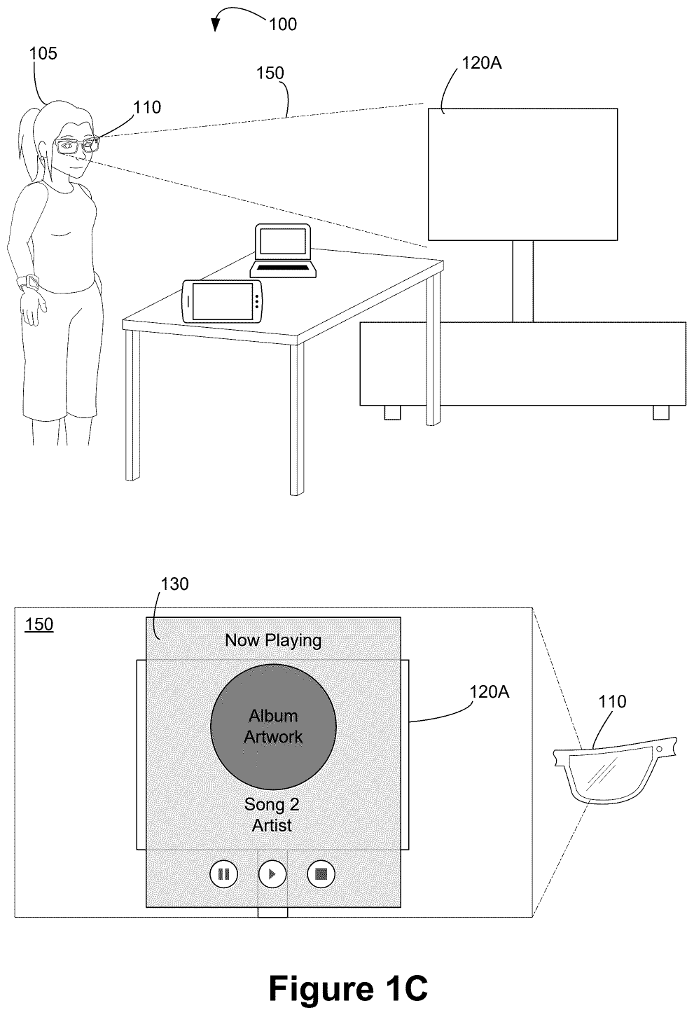

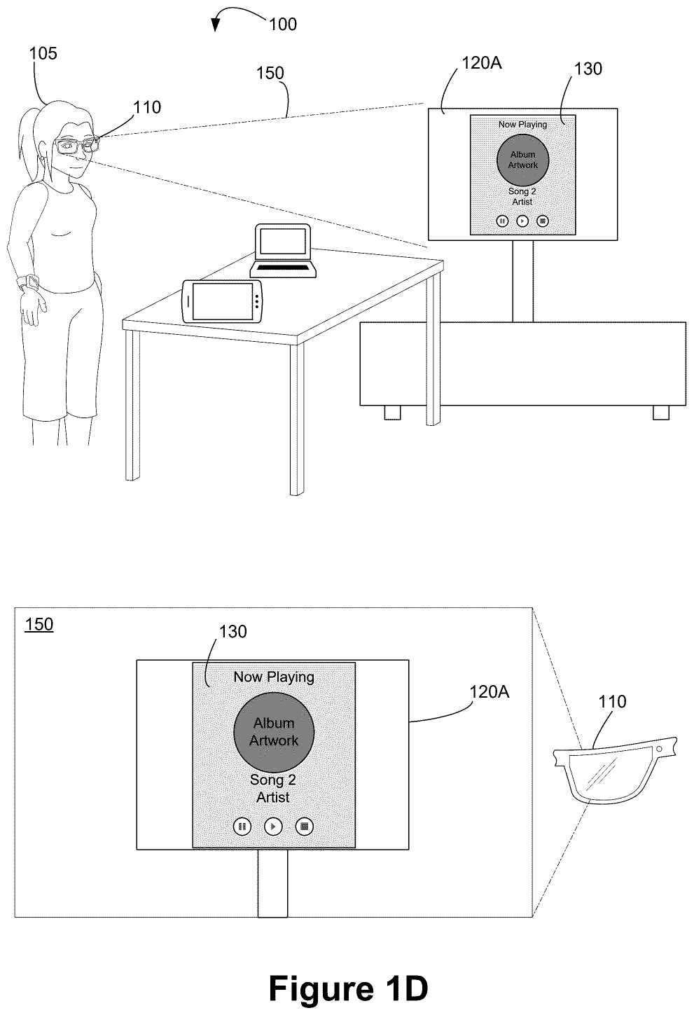

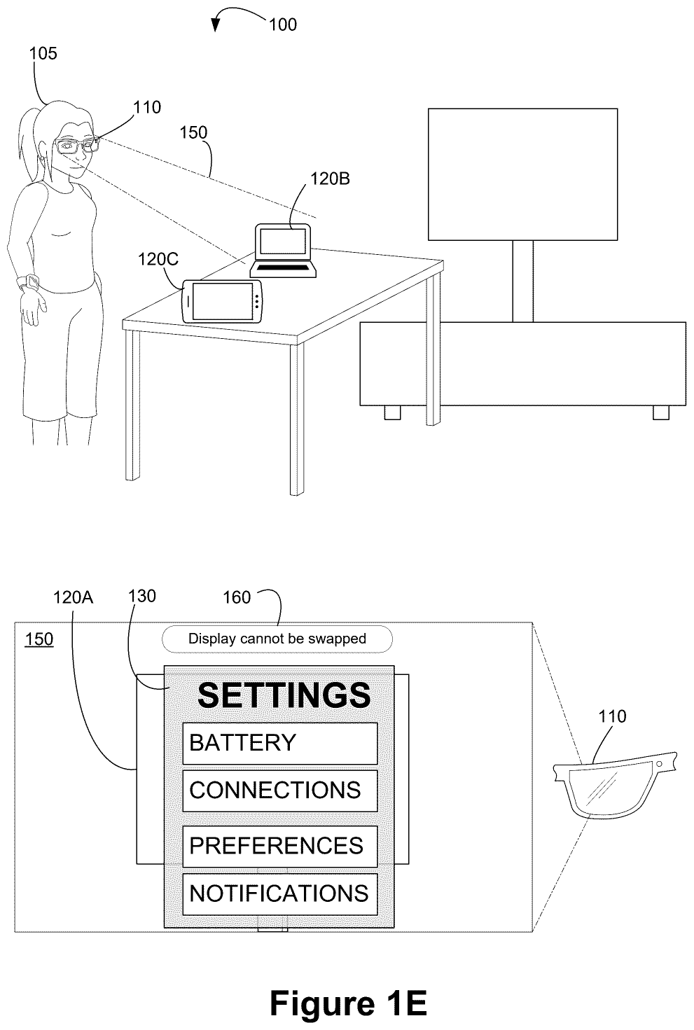

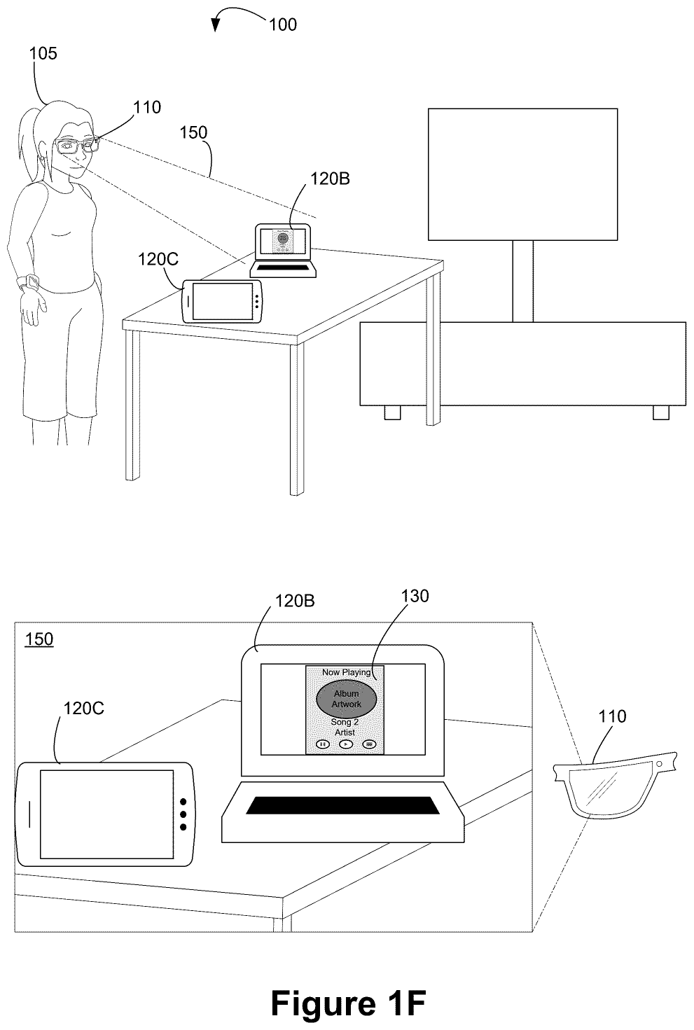

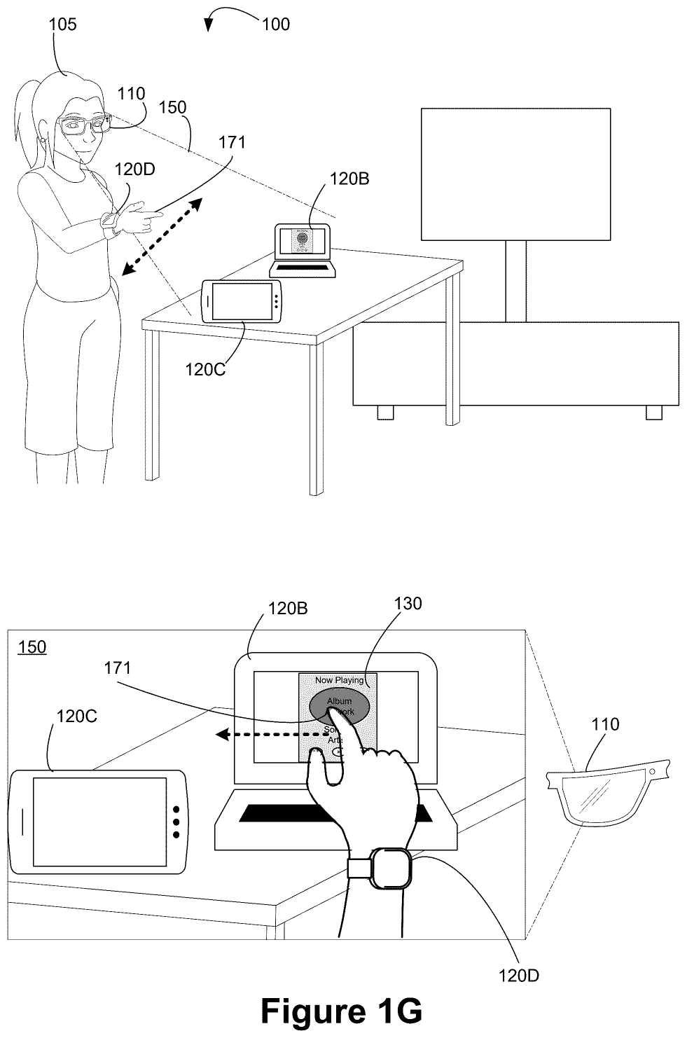

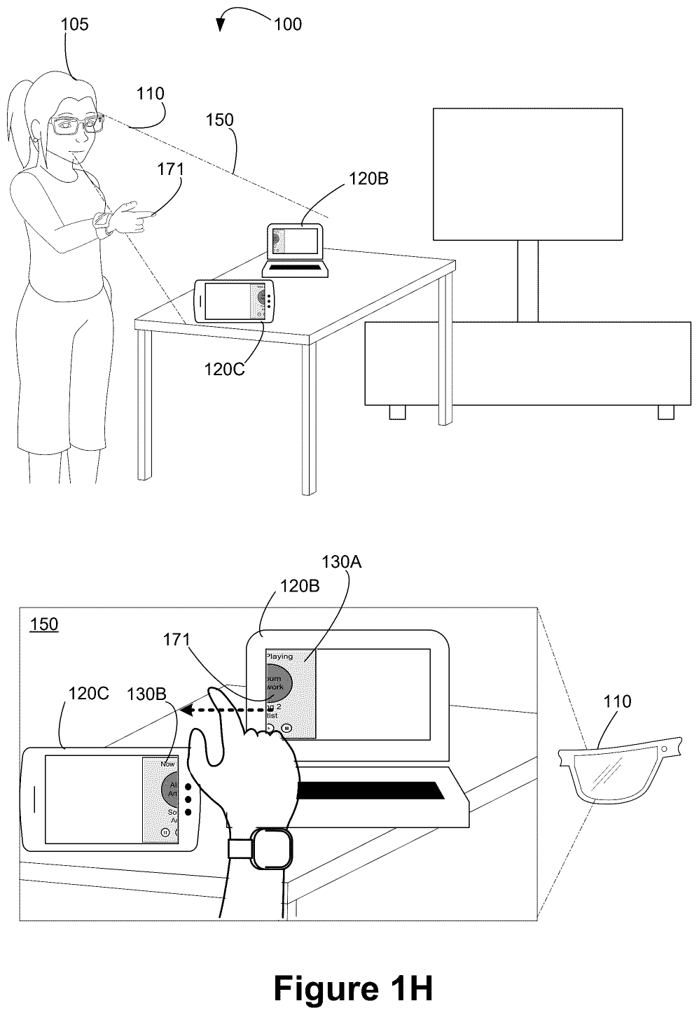

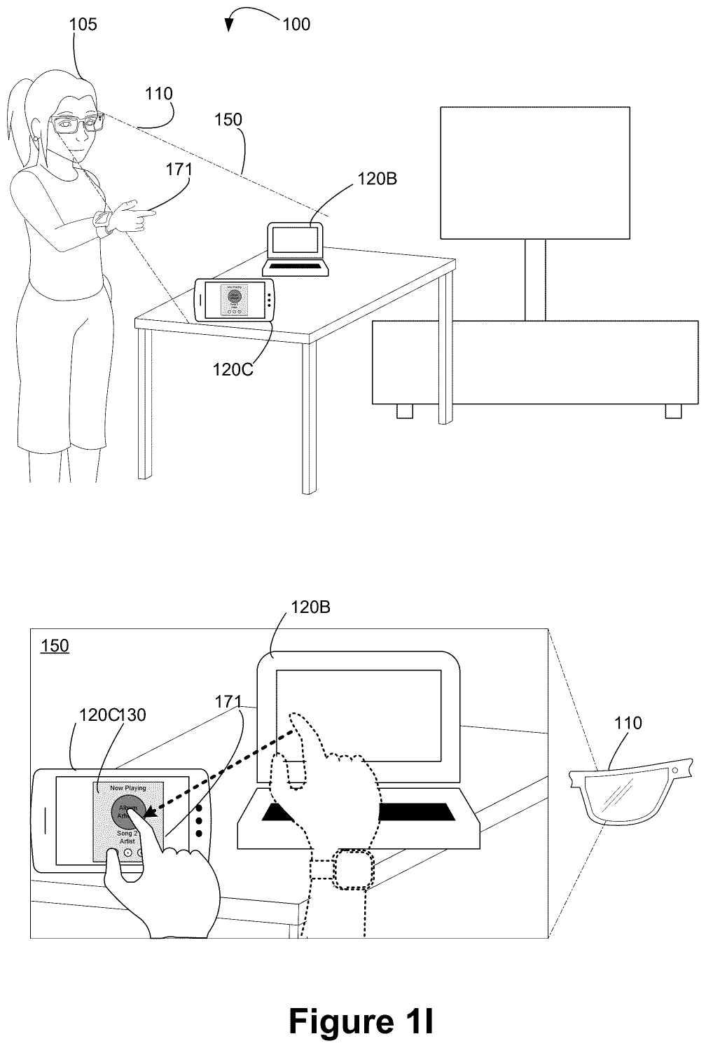

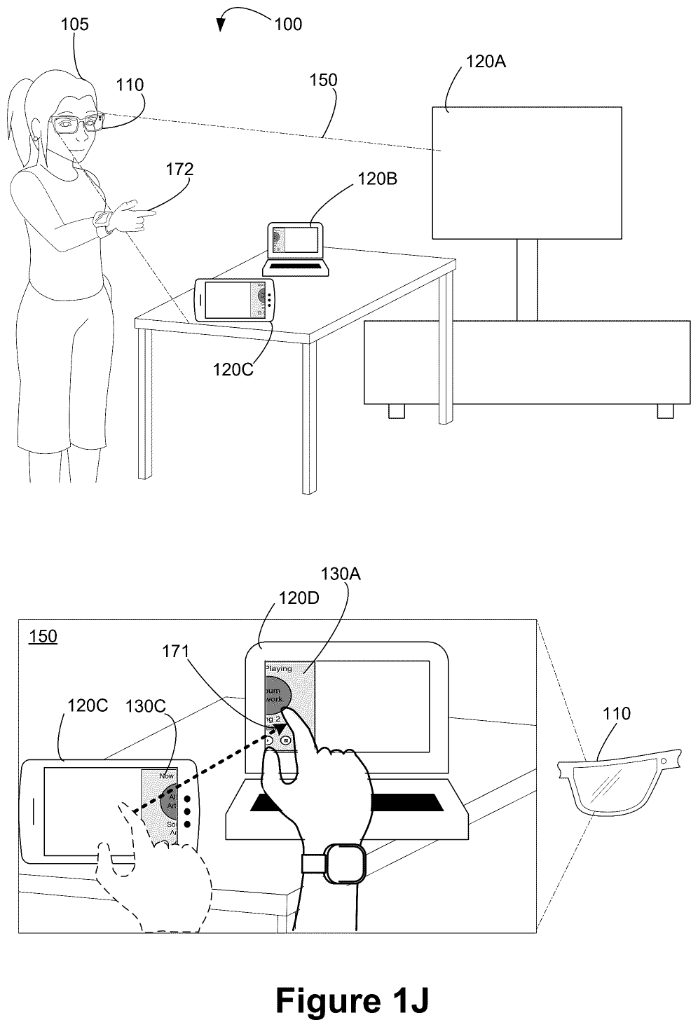

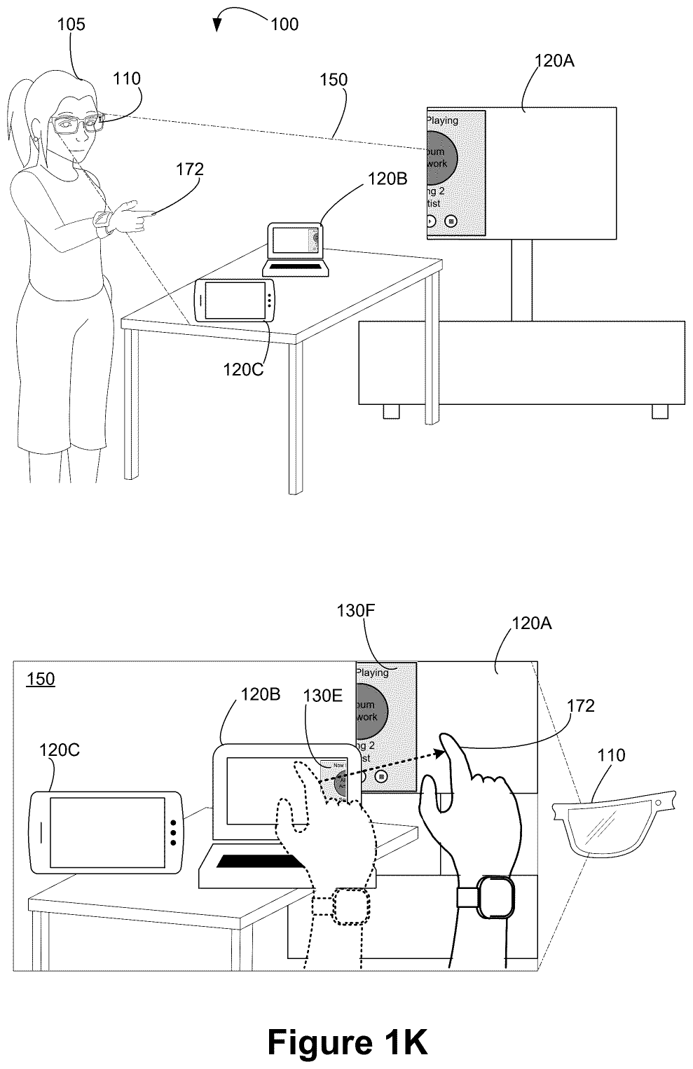

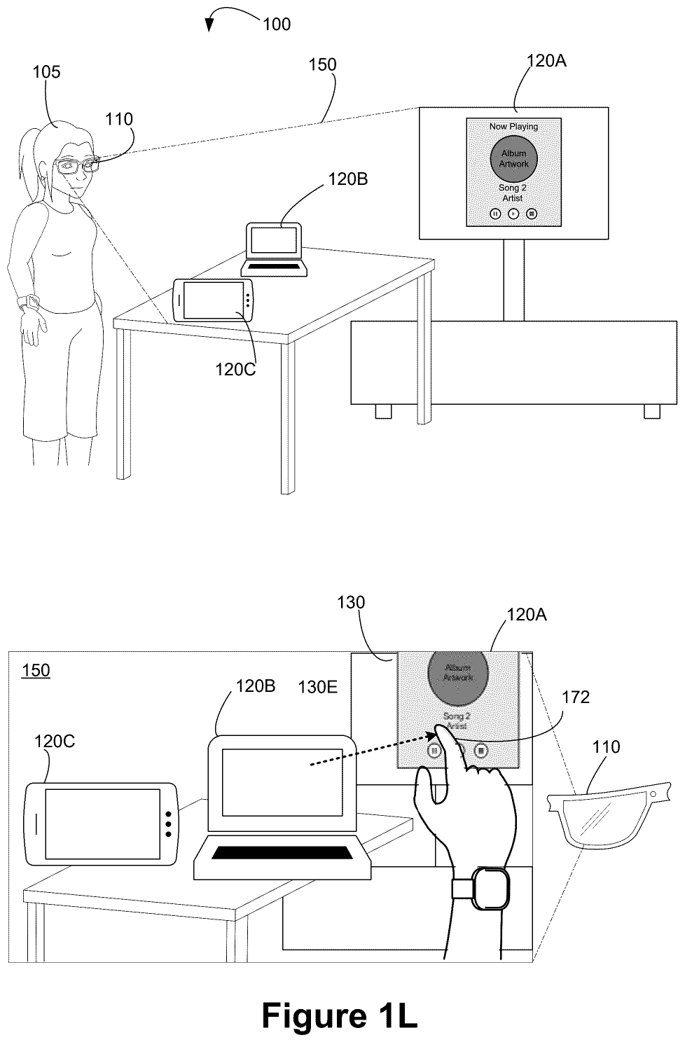

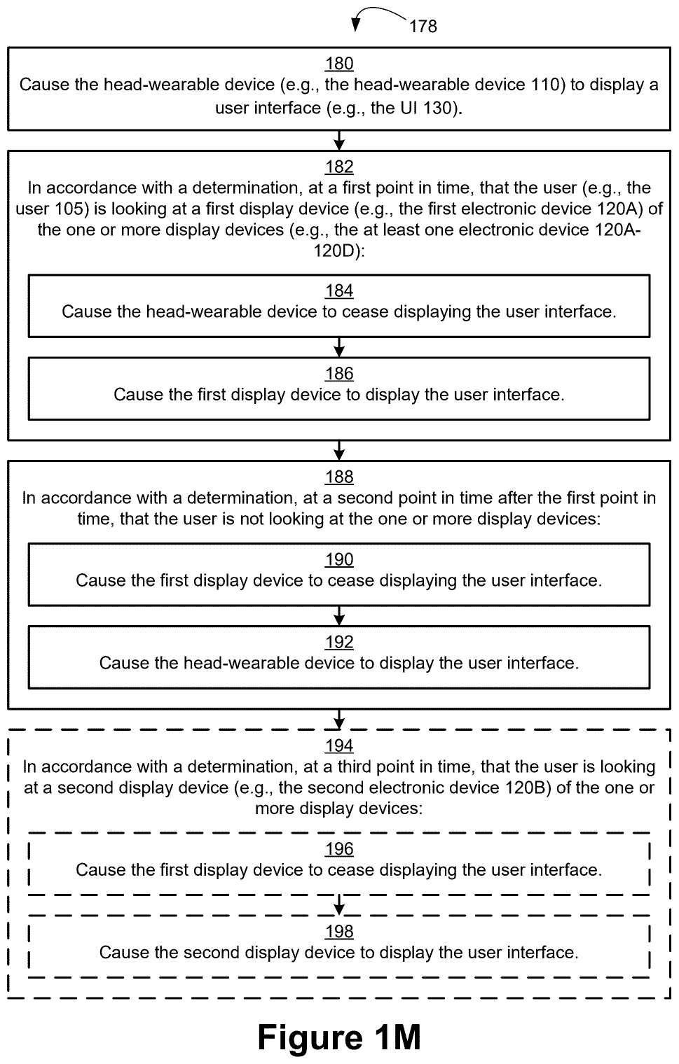

FIGS. 1A-1M illustrate an extended-reality (XR) system 100 for seamlessly switching display information, in the form of a user interface (UI) 130, between a plurality of displays, in accordance with some embodiments. FIG. 1A illustrates the XR system 100 including a user 105 wearing a head-wearable device 110 and at least one electronic device 120A-120D (e.g., a television 120A, a laptop 120B, a smartphone 120C, and/or a wrist-wearable device, as illustrated in FIGS. 1A-1K). The head-wearable device 110 and the at least one electronic device 120A-120D are communicatively coupled. Each electronic device of the at least one electronic device includes a display for presenting the UI 130 (and/or any other visual data) to the user 105. In some embodiments, the head-wearable device 110 is an XR headset, a pair of smart glasses, and/or smart contacts, including at least one display for presenting an XR environment (including the UI 130) to the user 105. In some embodiments, the XR system 100 includes another processing device (e.g., a handheld intermediary processing device) communicatively coupled to the head-wearable device 110 and/or the at least one electronic device 120A-120D, and for performing one or more operations described below. In some embodiments, the head-wearable device 110, the at least one electronic device 120A-120D, and/or the handheld intermediary processing device include respective computer readable storage mediums and processors for storing and executing instructions, respectively. FIG. 1A further illustrates the field-of-view 150 of the user 105. The field-of-view 150 is captured by an imaging device of the head-wearable device 110. In some embodiments, the field-of-view 150 is inferred by one or more sensors (e.g., inertial measurement unit (IMU), an electromyography (EMG) sensor, etc.) of the head-wearable device 110, a wrist-wearable device, and/or other communicatively coupled device.

FIG. 1B illustrates the head-wearable device 110 presenting the UI 130 (e.g., a music player interface, as illustrated in FIGS. 1B-1L) to the user 105, in accordance with some embodiments. The head-wearable device 110 presents the UI 130 to the user 105 via the at least one display of the head-wearable device 110. In some embodiments, the UI 130 is associated with an application and/or a program (e.g., a music-player application, as illustrated in FIG. 1B) executed at the head-wearable device 110, the at least one electronic device 120A-120D, and/or the other processing device. In some embodiments, the UI 130 is presented to appear over a center portion of the field-of-view 150 of the user 105, as illustrated in FIG. 1B. In some embodiments, the UI 130 is presented to appear over peripheral portion of the field-of-view 150 of the user 105 (e.g., such that the UI 130 does not obscure a center of the field-of-view 150 of the user 105).

FIG. 1C illustrates the user 105 changing the field-of-view 150 such that the user 105 is looking at the television 120A, in accordance with some embodiments. The head-wearable device 110 continues to display the UI 130 when the user 105 changes the field-of-view 150 (e.g., as illustrated in FIG. 1C). The user 105 changes the field-of-view 150 by moving their head and/or moving their body. In some embodiments, the UI 130 remains at the center portion of the field-of-view 150 as the user 105 changes the field-of-view, as illustrated in FIG. 1C. In some embodiments, the UI 130 moves to the peripheral portion of the field-of-view 150 as the user 105 changes the field-of-view (e.g., such that the UI 130 does not obscure a center of the field-of-view 150 of the user 105 while the user 105 is walking).

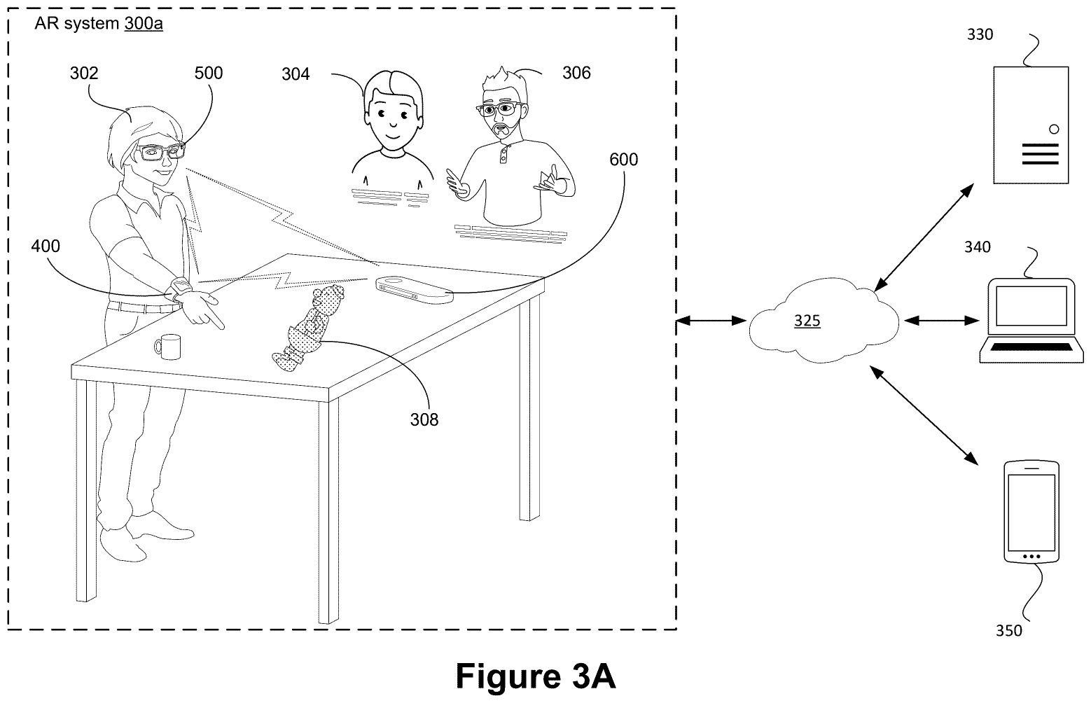

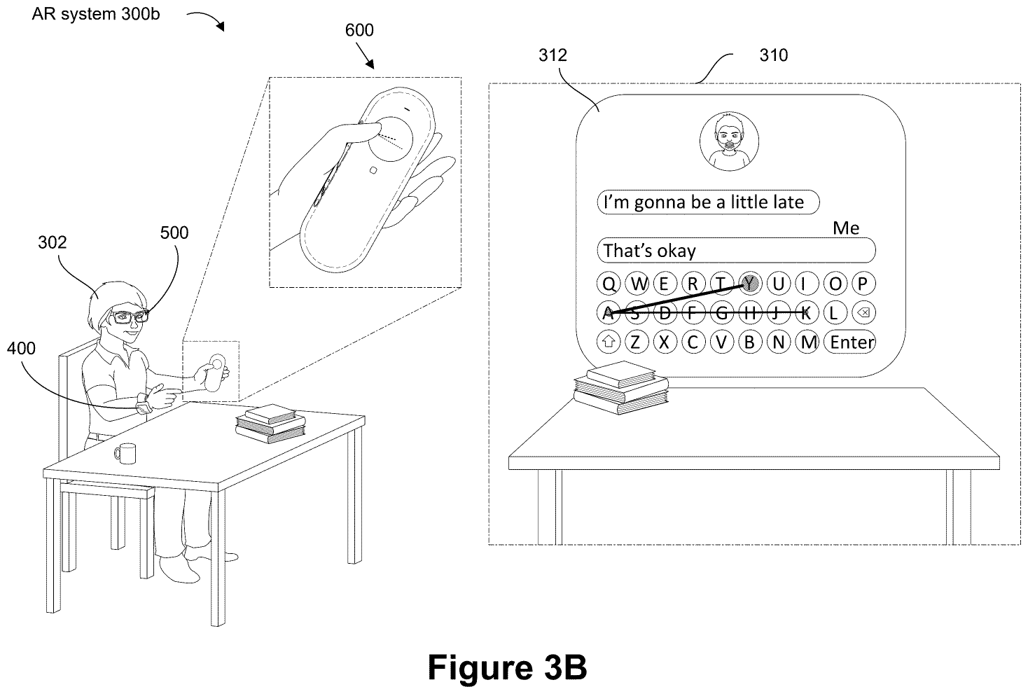

FIG. 1D illustrates the XR system 100 seamlessly switching the UI 130 from the display of the head-wearable device 110 to a display of a first electronic device 120A of the at least one electronic device 120A-120D (e.g., the television 120A, as illustrated in FIG. 1D), in accordance with some embodiments. The XR system 100, in seamlessly switching the UI 130 from the display of the head-wearable device 110 to the display of the first electronic device 120A, ceases to display the UI 130 at the head-wearable device and displays the UI 130 at the first electronic device 120A. In some embodiments, before ceasing to display the UI 130 at the head-wearable device and displaying the UI 130 at the first electronic device 120A, the UI 130, displayed at the head-wearable device 110, changes in size and/or shape as to appear, to the user 105, in the same proportions as when it is displayed at the first electronic device 120A. For example, the UI 130, displayed at the head-wearable device 110 as illustrated in FIG. 3C, decreases in size until it is at a second size, then the head-wearable device 110 ceases displaying the UI 130, and the first electronic device 120A displays the UI 130, which appears, to the user 105, at the second size. Thus, the UI 130 changing in size and/or shape as to appear, to the user 105, in the same proportions as when it is displayed at the first electronic device 120A makes the switching to appear as seamless to the user 105.

The XR system 100 seamlessly switches the UI 130 from the display of the head-wearable device 110 to the display of the first electronic device 120A in accordance with a determination that a first display switching condition is satisfied. In some embodiments, the first display switching condition is a determination that the user 105 is looking at the first electronic device 120A. In some embodiments, the determination that the user 105 is looking at the first electronic device 120A is based on eye tracking data (e.g., captured by an eye-tracking device of the head-wearable device 110) indicating a location of a gaze of the user 105 in the field-of-view 150, head location data and/or body location data (e.g., captured by an inertial measurement unit (IMU) sensor of the head-wearable device 110 and/or another body-worn device) indicating a direction that the user 105 is looking (e.g., an inferred view angle), and/or image data (e.g., captured by a forward-facing camera of the head-wearable device 110) indicating the field-of-view 150 of the user 105. In some embodiments, the first display switching condition is a determination that the user 105 is looking at the first electronic device 120A for a predetermined period of time. For example, the user 105 must look at the first electronic device 120A for five seconds to satisfy the first display switching condition. In some embodiments, the first display switching condition is a determination that the user 105 performs a select input (e.g., a hand gesture, a button press, and/or a voice command) while the user 105 is looking at the first electronic device 120A. For example, the user 105 looks at the first electronic device 120A and performs a hand gesture (e.g., a double finger-pinch) to satisfy the first display switching condition.

In some embodiments, the first display switching condition is a user input (e.g., a hand gesture, a button press, and/or a voice command) performed at the head-wearable device 110 and/or at the at least one electronic device 120A-120D. For example, the user 105 performs a voice command (e.g., “Show me this on the TV.”) to satisfy the first display switching condition. In some embodiments, the first display switching condition is a proximity between the head-wearable device 110 and the at least one electronic device 120A-120D. For example, the user 105 enters a room with the first electronic device 120A, and the head-wearable device 110 enters a threshold proximity (e.g., twenty feet) of the first electronic device 120A to satisfy the first display switching condition. In some embodiments, the first display switching condition is a determination that the at least one electronic device 120A-120D has been turned on. For example, the user 105 turns on the first electronic device 120A to satisfy the first display switching condition. In some embodiments, the first display switching condition is a determination that the head-wearable device 110 is below a battery threshold. For example, when the head-wearable device 110 drops below a ten-percent battery threshold, the first display switching condition is satisfied.

FIG. 1E illustrates the XR system 100 not seamlessly switching the UI 130 from the display of the head-wearable device 110 to the display of the first electronic device 120A, in accordance with some embodiments. In some embodiments, the first switching condition includes an additional determination that the UI 130 is of a switchable UI type that can be displayed at the at least one electronic device 120A-120D (e.g., a music player UI, as illustrated in FIGS. 1A-1D). In accordance with a determination that the UI 130 is of a unswitchable UI type that cannot be displayed at the at least one electronic device 120A-120D (e.g., a settings menu UI, as illustrated in FIG. 1E), the XR system 100 will not seamlessly switch the UI 130 to a display of the at least one electronic device 120A-120D and continue to display the UI 130 at the display of the head-wearable device 110. In some embodiments, in accordance with the determination that the UI 130 is of the unswitchable UI type, the head-wearable device 110n displays a notification 160, informing the user 105 that the UI 130 cannot be switched to the at least one electronic device 120A-120D. In some embodiments, the unswitchable UI type includes UIs associated with the head-wearable device 110 itself (e.g., the settings menu UI, as illustrated in FIG. 1E) and UIs that can only be displayed at the head-wearable device 110 (e.g., an XR game that relies on the XR capabilities of the head-wearable display).

In some embodiments, the first switching condition includes an additional determination that the at least one electronic device 120A-120D is of a switchable device type that can display the UI 130. In accordance with a determination that the at least one electronic device 120A-120D is of an unswitchable device type that cannot display the UI 130, the XR system 100 will not seamlessly switch the UI 130 to a display of the at least one electronic device 120A-120D and continue to display the UI 130 at the display of the head-wearable device 110. In some embodiments, in accordance with the determination that the UI 130 is of the unswitchable UI type, the head-wearable device 110n displays the notification 160, informing the user 105 that the UI 130 cannot be switched to the at least one electronic device 120A-120D. In some embodiments, the unswitchable device type includes devices that are not authorized for seamless switching (e.g., per a user setting), devices that are unable to present the UI 130 (e.g., due to hardware limitations and/or software limitations of the device), devices with a battery level below a battery threshold (e.g., a ten percent battery level), and/or devices with a connectivity level below a connectivity threshold (e.g., a connectivity level between the device and the head-wearable device 110, the other processing device, and/or the Internet).

FIG. 1F illustrates the XR system 100 seamlessly switching the UI 130 from the display of the first electronic device 120A to a display of a second electronic device 120B of the at least one electronic device 120A-120D (e.g., the laptop 120B, as illustrated in FIG. 1F), in accordance with some embodiments. The XR system 100, in switching the UI 130 from the display of the first electronic device 120A to a display of a second electronic device 120B, ceases to display the UI 130 at the first electronic device 120A and displays the UI 130 at the second electronic device 120B. In some embodiments, the XR system 100 switches the UI 130 from the display of the first electronic device 120A to a display of a second electronic device 120B in accordance with a determination that a second display switching condition is satisfied. In some embodiments, the second display switching condition is a determination that the user 105 is looking at the second electronic device 120B. In some embodiments, the second display switching condition is a determination that the user 105 is looking at the second electronic device 120B for the predetermined period of time. In some embodiments, the second display switching condition is a determination that the user 105 performs the select input while the user 105 is looking at the second electronic device 120B. In some embodiments, the second display switching condition is the user input performed at the head-wearable device 110 and/or at the at least one electronic device 120A-120D. For example, the user 105 performs another voice command (e.g., “Now show me this on the computer.”) to satisfy the second display switching condition.

In accordance with a determination that a third switching condition is satisfied, the XR system 100 causes the first electronic device 120A and/or the second electronic device 120B cease displaying the UI 130, and the head-wearable device 110 displays the UI 130 again. In some embodiments, the third display switching condition is a determination that the user 105 is not looking at any of the at least one electronic device 120A-120D. In some embodiments, the third display switching condition is a determination that the user 105 has stopped looking at any of the at least one electronic device 120A-120D for a second predetermined period of time (e.g., ten second). In some embodiments, the third display switching condition is a determination that the user 105 performs a deselect input while the user 105 is not looking at any of the at least one electronic device 120A-120D. In some embodiments, the third display switching condition is the user input performed at the head-wearable device 110 and/or at the at least one electronic device 120A-120D. For example, the user 105 performs an additional voice command (e.g., “Show me this at my glasses.”) to satisfy the third display switching condition.

FIGS. 1G-1I illustrate the XR system 100 seamlessly switching the UI 130 between a display of the second electronic device 120B and a display of a third electronic device 120C (e.g., the smartphone 120C, as illustrated in FIG. 1G), in accordance with some embodiments. FIG. 1G illustrates the second electronic device presenting the UI 130. The user 105 performs a first gesture 171 (e.g., a left-swipe gesture, as illustrated in FIG. 1H), which satisfies a fourth display switching condition, to seamlessly switch the UI 130 from the display of the second electronic device 120B to the display of the third electronic device 120C. In some embodiments, the fourth switching condition is based on a location of the third electronic device 120C relative to the second electronic device 120B and the user 105 and/or the head-wearable device 110. The fourth switching condition is satisfied when the user 105 performs the first gesture 171 in a direction from a location of the second electronic device 120B to the location of the third electronic device 120C from the point-of-view of the user 105. For example, when the user performs the first gesture 171 from right-to-left, while the third electronic device 120C is to the left of the second electronic device 120B, from the point-of-view of the user 105, the fourth switching condition is satisfied, as illustrated in FIG. 1G. If the user performs a gesture in a different direction (e.g., a top-to-bottom swipe gesture), the fourth switching condition is not satisfied.

FIG. 1H illustrates the XR system 100 while the user 105 is performing the first gesture 171, in accordance with some embodiments. As the user 105 performs the first gesture 171, the second electronic device 120B displays a first portion 130A of the UI 130, and the third electronic device 120C displays a second portion 130B of the UI 130, distinct from the first portion 130A. In some embodiments, the first portion 130A and second portion 130B are such that the UI 130 appears to seamlessly switch between the display of the second electronic device 120B and the display of the third electronic device 120C, as illustrated in FIG. 1H. In some embodiments, the first portion 130A and second portion 130B are such that the UI 130 appears to follow the first gesture 171 (e.g., at a same speed). FIG. 1I illustrates the XR system 100 after the user 105 has completed the first gesture 171, in accordance with some embodiments. In accordance with a determination that the user 105 has completed the first user input 171, the second electronic device 120B ceases displaying the first portion 130A of the UI 130, and the third electronic device 120C displays the UI 130. In some embodiments, if the user 105 stops performing the first gesture 171 while the second electronic device 120B is displaying the first portion 130A of the UI 130 and the third electronic device 120C is displaying the second portion 130B of the UI 130, the UI 130 will be displayed at the second electronic device 120B if the first portion 130A is larger than the second portion 130B and the UI 130 will be displayed at the third electronic device 120C if the first portion 130A is smaller than the second portion 130B, at a time that the user 105 stops performing the first gesture 171. For example, the UI 130 will appear to snap to either second electronic device 120B or the third electronic device 120C if the user 105 stops performing the first gesture 171 while the UI 130 appears to be moving between the two devices.

FIGS. 1J-1L illustrate the XR system 100 switching the UI 130 from the display of the third electronic device 120C to the display of the second electronic device 120B and further to the display of the first electronic device 120A, in accordance with some embodiments. The user 105 performs a second gesture 172 (e.g., a long left-to-right swipe gesture, as illustrated in FIGS. 1J-1L), which satisfies a fifth display switching condition to seamlessly switch the UI 130 from the display of the third electronic device 120C, to the display of the second electronic device 120B, and further to the display of the first electronic device 120A. In some embodiments, the fifth switching condition is based on a location of the first electronic device 120A and the second electronic device 120B relative to the third electronic device 120C and the user 105 and/or the head-wearable device 110. The fifth switching condition is satisfied when the user 105 performs the second gesture 172 in a direction from the location of the third electronic device 120C, across the location of the second electronic device 120B, and to the location of the first electronic device 120A from the point-of-view of the user 105. For example, when the user performs the second gesture 172 from left-to-right, while the third electronic device 120C is to the left of the second electronic device 120B and the second electronic device is to the left of the first electronic device 120A, from the point-of-view of the user 105, the fourth switching condition is satisfied, as illustrated in FIGS. 1J-1L. If the user performs another gesture in a different direction (e.g., a right-to-left swipe gesture), the fifth switching condition is not satisfied.

FIG. 1J illustrates the XR system 100 while the user 105 performs the second gesture 172, in accordance with some embodiments. As the user 105 performs the second gesture 172, the third electronic device 120C displays a third portion 130C of the UI 130, and the second electronic device 120B displays a fourth portion 130D of the UI 130, distinct from the third portion 130C. In some embodiments, the third portion 130C and fourth portion 130D are such that the UI 130 appears to seamlessly switch between the display of the third electronic device 120C and the display of the second electronic device 120B, as illustrated in FIG. 1J. FIG. 1K illustrates the XR system 100 while the user 105 continues to perform the second gesture 172, in accordance with some embodiments. As the user 105 continues to perform the second gesture 172, the second electronic device 120B displays a fifth portion 130E of the UI 130, and the first electronic device 120A displays a sixth portion 130F of the UI 130, distinct from the fifth portion 130E. In some embodiments, the fifth portion 130E and sixth portion 130F are such that the UI 130 appears to seamlessly switch between the display of the second electronic device 120B and the display of the first electronic device 120A, as illustrated in FIG. 1K. In some embodiments, after the second electronic device 120A displays the fourth portion 130D and before the second electronic device 120A displays the fifth portion 130E, the second electronic device 120B displays the UI 130 such that the UI 130 appears to seamless switch from the display of the third electronic device 120C to the display of the second electronic device 120B and onto the display of the first electronic device 120A (e.g., the UI 130 appears to slide from the smartphone 130C to the laptop 120B, and to the television 120A, as illustrated in FIGS. 1J-1L). FIG. 1L illustrates the XR system 100 after the user 105 has completed the second gesture 172, in accordance with some embodiments. In accordance with a determination that the user 105 has completed the second gesture 172, the second electronic device 120B ceases displaying the fifth portion 130E of the UI 130, and the first electronic device 120A displays the UI 130.

In some embodiments, the first gesture 171 and/or the second gesture 172 is a hand gesture performed by the user and determined based on image data captured at a camera of the head-wearable device 110, IMU data captured at an IMU sensor of the wrist-wearable device 120D, and/or biopotential data (e.g., electromyography (EMG) data) captured at a biopotential sensor of the wrist-wearable device 120D. In some embodiments, the first gesture 171 and/or the second gesture 172 is a gaze gesture (e.g., moving a focus of the user's gaze) performed by the user 105 and is determined based on eye-tracking data, head location data and/or body location data, and/or image data (e.g., the user 105 gazes at an electronic device of at least one electronic device 120A-120C to seamlessly switch the UI 130).

FIG. 1M illustrates a flow diagram of a method 178 for seamless UI switching, in accordance with some embodiments. Operations (e.g., steps) of the method 178 can be performed by one or more processors (e.g., central processing unit and/or MCU) of the XR system 100. At least some of the operations shown in FIG. 1M correspond to instructions stored in a computer memory or computer-readable storage medium (e.g., storage, RAM, and/or memory) of the XR system 100. Operations of the method 178 can be performed by a single device alone or in conjunction with one or more processors and/or hardware components of another communicatively coupled device (e.g., the head-wearable device 110) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device but should not be construed as limiting the performance of the operation to the particular device in all embodiments.

In accordance with some embodiments, the method 178 occurs while a head-wearable device (e.g., the head-wearable device 110), worn by a user (e.g., the user 105), is communicatively coupled to one or more display devices (e.g., the at least one electronic devioce 120A-120D). The method 178 includes causing the head-wearable device to display a user interface (e.g., the UI 130) (180). The method 178 further includes, in accordance with a determination, at a first point in time, that the user is looking at a first display device of the one or more display devices (182): (i) causing the head-wearable device to cease displaying the user interface (184) and (ii) cause the first display device to display the user interface (186). The method 178 further includes, in accordance with a determination, at a second point in time after the first point in time, that the user is not looking at the one or more displays devices (188): (i) causing the first display device to cease displaying the user interface (190) and (ii) causing the head-wearable device to display the user interface (192). In some embodiments, the method 178 further includes, in accordance with a determination, at a third point in time, that the user is looking at a second display device (e.g., the second electronic device 120B) of the one or more display devices (194): (i) causing the first display device to cease displaying the user interface (196) and (ii) causing the second display device to display the user interface (198).

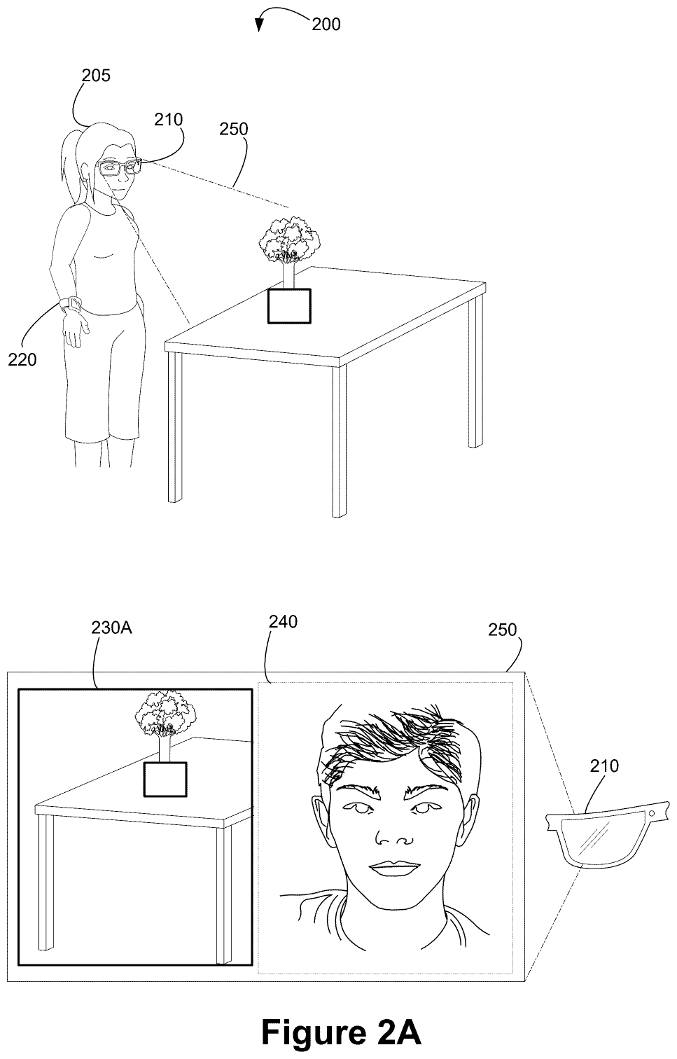

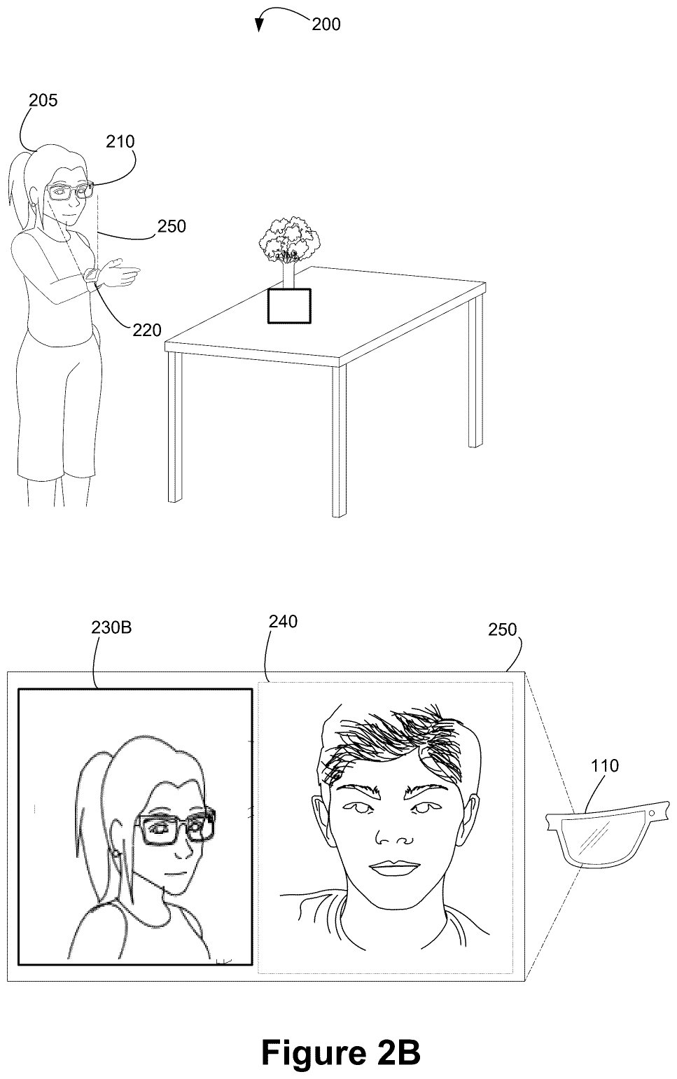

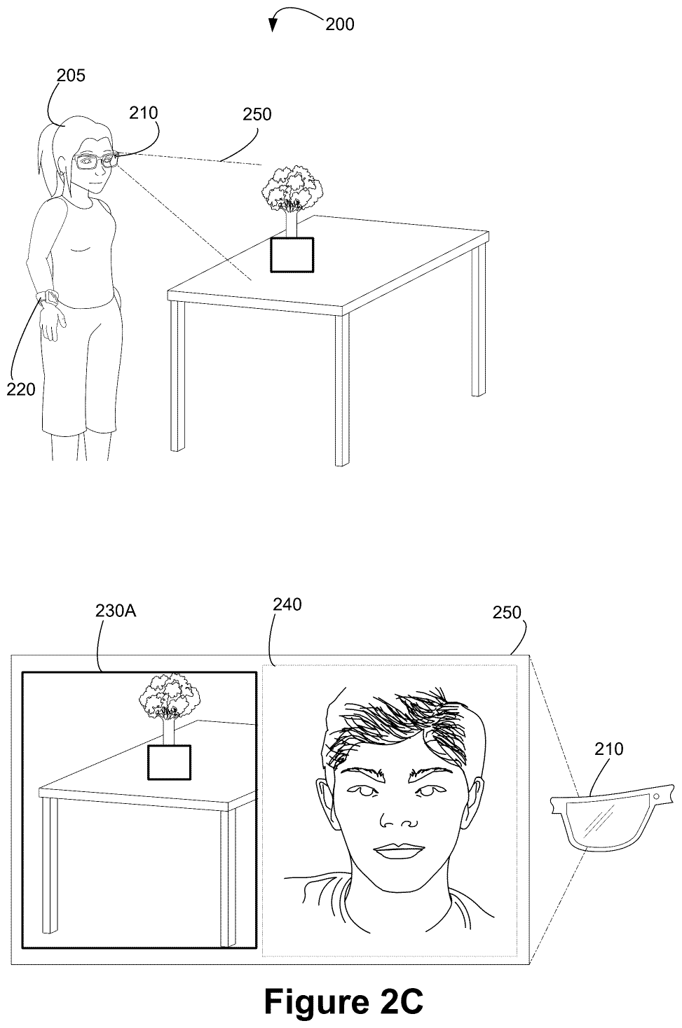

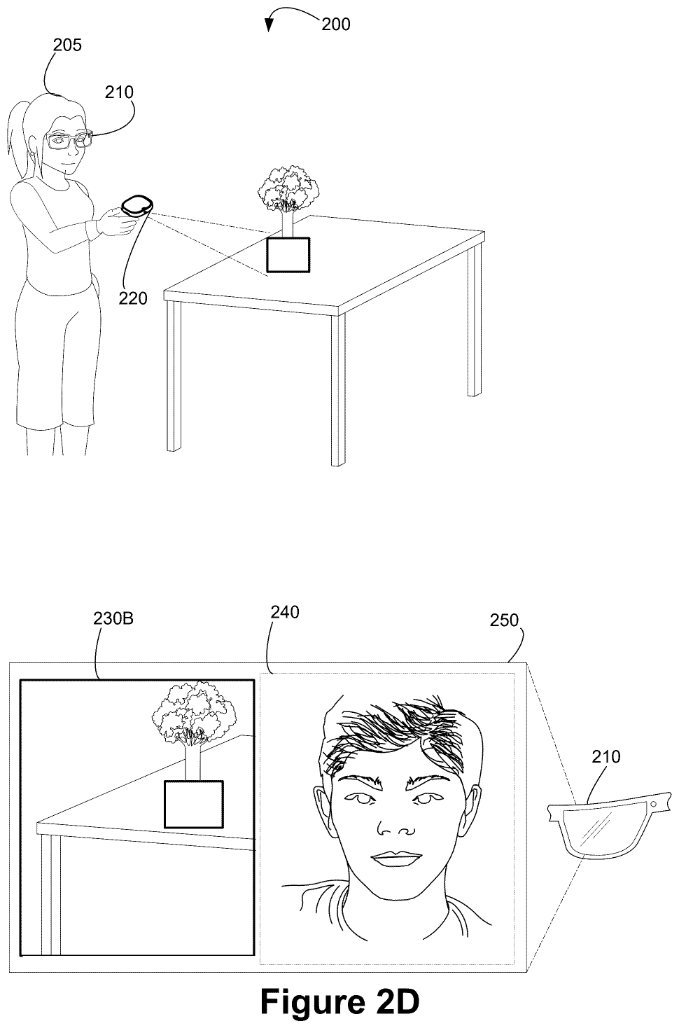

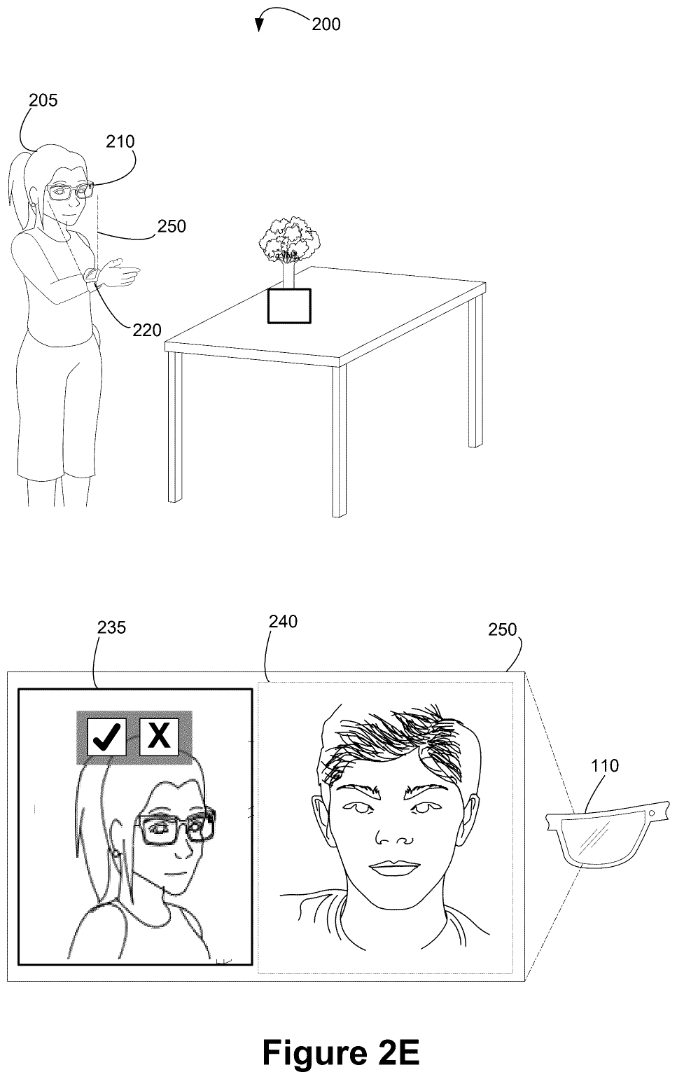

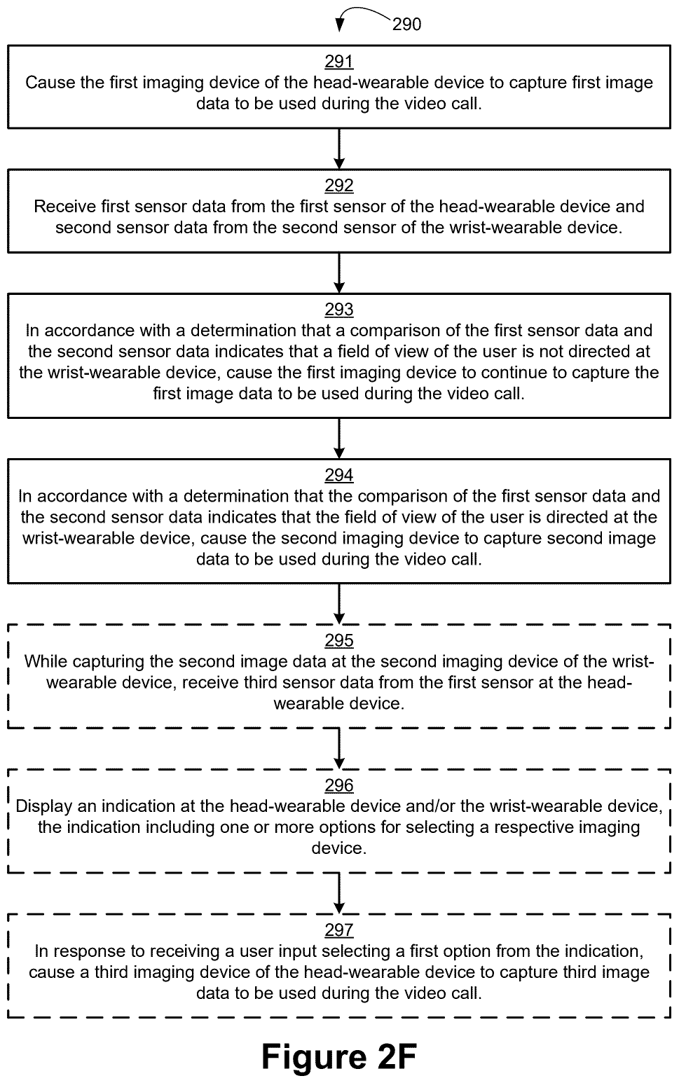

FIGS. 2A-2D illustrates another XR system 200 for switching between cameras for capturing image data for a video call, in accordance with some embodiments. FIG. 2A illustrates the XR system 200 including a user 205 wearing a head-wearable device 210 and a wrist-wearable device 220, in accordance with some embodiments. The head-wearable device 210 and the wrist-wearable device 220 are communicatively coupled. In some embodiments, the XR system 200 further includes a handheld intermediary processing device communicatively coupled with the head-wearable device 210 and/or the wrist-wearable device 220. The head-wearable device 210 includes at least one display for presenting XR elements, at least one camera for capturing first image data of a field-of-view 250 of the user 205 (e.g., two cameras on either side of a frame of the head-wearable device 210), and at least one microphone for capturing audio data. The head-wearable device 220 also includes a first sensor (e.g., an eye-tracking camera and/or an IMU) to determine a gaze of the user 205. The wrist-wearable device 220 includes at least one camera for capturing second image data (e.g., a camera on the face of the wrist-wearable device 220 and another camera on a rear side of the wrist-wearable device 220). In some embodiments, the wrist-wearable device 220 includes a second sensor (e.g., an IMU and/or EMG sensor) for determining hand gestures performed by the user 205. In some embodiments, the head-wearable device 210, the wrist-wearable device 220, and/or a handheld intermediary processing device include a computer readable storage medium and one or more processors for storing and executing instructions, respectively.

In FIG. 2A, the XR system 200 is used to perform a video call between the user 205 and another user of another device by presenting call video data and call audio data from the other user, as well as video data, which is captured by the head-wearable device 210 and/or the wrist-wearable device 220. The video data, along with audio data captured by a microphone of the head-wearable device 210 and/or the wrist-wearable device 220, is used for the video call and is communicated to the other user. The call video data 240, the call audio data, and the video data (e.g., the first image data 230A, as illustrated in FIG. 2A) are presented at the head-wearable device 210 and/or the wrist-wearable device 220, (e.g., the call video data 240 is presented at a right portion of the display of the head-wearable device 210, the video data is presented at a left portion of the display of the head-wearable device 210, as illustrated in FIG. 2A, and the call audio data is presented at a speaker of the wrist-wearable device 220 and/or the at least one speaker of the head-wearable device 210). In some embodiments, the first image data 230A captured by the at least one camera of the head-wearable device 210 is used for the video data, as illustrated in FIG. 2A.

FIG. 2B illustrates the XR system 200 automatically switching the video data used for the video call from the first image data 230A, captured at the head-wearable device 210, to the second image data 230B, captured at the wrist-wearable device 220, in accordance with some embodiments. The switching the video data from the first image data 230A to the second image data 230B causes the at least one camera of the head-wearable device 210 to stop capturing the first image data 230A, causes the at least one camera of the wrist-wearable device 220 to capture the second video data 230B, and causes the second image data 230B to be used as the video data (e.g., as illustrated in FIG. 2B, as the second image data 230B presented at the head-wearable device 210). The switching the video data from the first image data 230A to the second image data 230B is in accordance with a determination that the user 205 is looking at the wrist-wearable device 220. In some embodiments, in accordance with a determination that the user 205 is not looking at the wrist-wearable device 220, the at least one camera of the head-wearable device continues to capture the first image data 230A and the first image data 230A continues to be used at the video data. The determination that the user 205 is looking at the wrist-wearable device 220 is made from a comparison of first sensor data captured by the first sensor of the head-wearable device 210 (e.g., a location of the user's gaze within the field-of-view 250) and second sensor data captured by the second sensor of the wrist-wearable device 220 (e.g., a location of the wrist-wearable device 220 with respect to the head-wearable device 210).

FIG. 2C illustrates the XR system 200 automatically switching the video data used for the video call from the second image data 230B, captured at the wrist-wearable device 220, back to the first image data 230A, captured at the head-wearable device 210, in accordance with some embodiments. The switching the video data from the second image data 230B back to the first image data 230A causes the at least one camera of the wrist-wearable device 220 to stop capturing the second image data 230B, causes the at least one camera of the head-wearable device 210 to capture the first video data 230A again, and causes the first image data 230A to, again, be used as the video data. The switching the video data from the second image data 230B back to the first image data 230A is in accordance with a determination that the user 205 is no longer looking at the wrist-wearable device 220. The determination that the user 205 is looking at the wrist-wearable device 220 is made from a second comparison of new first sensor data and new second sensor data captured a period of time after the first comparison was made.

In some embodiments, the user 205 may override the automatic switching of the video data used for the video call. FIG. 2D illustrates a first example override of the automatic switching of the video data, in accordance with some embodiments. In accordance with a determination that the user 205 has removed the wrist-wearable device 220, the video data switches to the second image data 230B, captured at the wrist-wearable device 220, regardless of whether the user 205 is looking at the wrist-wearable device 220 (e.g. the user 205 removes the wrist-wearable device 220 from a wrist-strap and the video data switches to the second image data 230, as illustrated in FIG. 2D). FIG. 2E illustrated a second example override of the automatic switching of the video data, in accordance with some embodiments. In accordance with the determination that the user 205 is looking at the wrist-wearable device 220, the head-wearable device 210 displays a preview 235 of the second image data 230B. While the preview is displayed to the user 205, the first image data 230A continues to be captured at the head-wearable device 210, and the first image data 230A continues to be used as the video data, but the second image data 230B is captured at the wrist-wearable device 220 and is presented to the user 205 at the at least one display of the head-wearable device 210 (e.g., as illustrated in FIG. 2E). The user 205 can choose, via the preview 235, to continue to use the first image data 230A as the video data or to switch to using to the second image data 230B as the video data. FIG. 2F illustrates a third override of the automatic switching of the video data, in accordance with some embodiments.

In some embodiments, the XR system 200 enhances the video data. The XR system 200 enhances the video data by auto-leveling the first image data 230A and/or the second image data 230B (e.g., the second image data 230B may appear skewed due to the at least one camera of the wrist-wearable device 220 being located on a user's wrist, so the XR system 20 auto-levels the second image data 230B such that the user 205 appears upright in the video data). The XR system 200 enhances the video data by stabilizing the first image data 230A and/or the second image data 230B (e.g., the first image data 230A and/or the second image data 230B may appear shaky due to the user 205 walking while participating in the video call, so the XR system 200 stabilizes first image data 230A and/or the second image data 230B such that the user 205 appears clearly in the video data).

FIG. 2F illustrates a flow diagram of a method for switching between cameras for capturing image data for a video call, in accordance with some embodiments. Operations (e.g., steps) of the method 290 can be performed by one or more processors (e.g., central processing unit and/or MCU) of the XR system 200. At least some of the operations shown in FIG. 2F correspond to instructions stored in a computer memory or computer-readable storage medium (e.g., storage, RAM, and/or memory) of the XR system 200. Operations of the method 290 can be performed by a single device alone or in conjunction with one or more processors and/or hardware components of another communicatively coupled device (e.g., the head-wearable device 210) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device but should not be construed as limiting the performance of the operation to the particular device in all embodiments.

In accordance with some embodiments, the method 290 begins when the XR system 200, causes the first imaging device of the head-wearable device 210 to capture first image data 230A to be used during the video call 291. The XR system 200 further receives first sensor data from the first sensor of the head-wearable device 210 and second sensor data from the second sensor of the wrist-wearable device 220 292. The XR system 200 further, in accordance with a determination that a comparison of the first sensor data and the second sensor data indicates that a field-of-view 250 of the user 205 is not directed at the wrist-wearable device 220, causes the first imaging device to continue to capture the first image 230A data to be used during the video call 293. The XR system 200 further, in accordance with a determination that the comparison of the first sensor data and the second sensor data indicates that the-field-of view 250 of the user 205 is directed at the wrist-wearable device 220, causes the second imaging device to capture second image data 230B to be used during the video call 294. In some embodiments, the XR system 200 further, while capturing the second image data 230B at the second imaging device of the wrist-wearable device 220, receives third sensor data from the first sensor at the head-wearable device 210 295. In some embodiments, the XR system 200 further displays an indication at the head-wearable device 210 and/or the wrist-wearable device 220, the indication including one or more options for selecting a respective imaging device 296. In some embodiments, the XR system 200 further, in response to receiving a user input selecting a first option from the indication, causes a third imaging device of the head-wearable device 210 to capture third image data to be used during the video call 297.

(A1) In accordance with some embodiments, a non-transitory computer readable storage medium including executable instructions that, when executed by a computing device (e.g., the head-wearable device 110, the at least one electronic device 120A-120D, and/or the other processing device), cause the computing device to perform actions while a head-wearable device (e.g., the head-wearable device 110), worn by a user (e.g., the user 105), is communicatively coupled to one or more display devices (e.g., the at least one electronic device 120A-120D). The instructions cause the computing device to cause the head-wearable device to display a user interface (e.g., the UI 130). The instructions further cause the computing device to, in accordance with a determination, at a first point in time, that the user is looking at a first display device (e.g., the first electronic device 120A) of the one or more display devices: (i) cause the head-wearable device to cease displaying the user interface and (ii) cause the first display device to display the user interface. The instructions further cause the computing device to, in accordance with a determination, at a second point in time after the first point in time, that the user is not looking at the one or more displays devices: (i) cause the first display device to cease displaying the user interface and (ii) cause the head-wearable device to display the user interface.

(A2) In some embodiments of A1, (i) causing the head-wearable device to cease displaying the user interface and causing the first display device to display the user interface are further in accordance with a determination that the user performs a select input (e.g., a hand gesture) and (ii) causing the first display device to cease displaying the user interface and causing the head-wearable device to display the user interface are further in accordance with a determination that the user performs another select input.

(A3) In some embodiments of any of A1-A2, (i) the determination that the user is looking at the first display device of the one or more display devices includes determining that the user is looking at the first display device for a first predetermined period of time, and (ii) the determination that the user is not looking at the one or more displays devices includes determining that the user is has not looked at any of the one or more display devices for a second predetermined period of time.

(A4) In some embodiments of any of A1-A3, causing the head-wearable device to cease displaying the user interface and causing the first display device to display the user interface are further in accordance with a determination that the first display device is of display type that can display the user interface.

(A5) In some embodiments of any of A1-A4, the instructions further cause the computing device to, in accordance with a determination, at a third point in time, that the user is looking at a second display device of the one or more display devices: (i) cause the first display device to cease displaying the user interface and (ii) cause the second display device to display the user interface. The instructions further cause the computing device to, in accordance with a determination, at a fourth point in time after the third point in time, that the user is not looking at the one or more displays devices: (i) cause the second display device to cease displaying the user interface and (ii) cause the head-wearable device to display the user interface.

(A6) In some embodiments of any of A1-A5, the instructions further cause the computing device to, in accordance with a determination, at a fifth point in time after the second point in time, that the user is looking at a third display device of the one or more display devices: (i) cause the head-wearable device to cease displaying the user interface and (ii) cause the third display device to display the user interface. The instructions further cause the computing device to, in accordance with a determination, at a fourth point in time after the sixth point in time after the fifth point in time, that the user is not looking at the one or more displays devices: (i) cause the third display device to cease displaying the user interface and (ii) cause the head-wearable device to display the user interface.

(A7) In some embodiments of A1-A6, the instructions further cause the computing device to, in response to a switch input, performed by the user and indicating a fourth display device of the one or more display devices: (i) cause the first display device to cease displaying the user interface and (ii) cause the fourth display device to display the user interface.

(A8) In some embodiments of any of A1-A7, the instructions further cause the computing device to, in response to another switch input, indicating a fourth display device of the one or more display devices: (i) cause the third display device to cease displaying the user interface and (ii) cause the fourth display device to display the user interface.

(A9) In some embodiments of any of A1-A8, the instructions further cause the computing device to, in response to the switch input, indicating the fourth display device of the one or more display devices, and before causing the first display device to cease displaying the user interface and causing the fourth display device to display the user interface: (i) cause the first display device to display a first portion of the user interface and (ii) cause the fourth display device to display a second portion of the user interface. The user interface appears to slide from the first display device to the fourth display device.

(A10) In some embodiments of any of A1-A9, the switch input is at least one of a hand gesture, a voice command, and a button press.

(A11) In some embodiments of any of A1-A10, the determination that the user is looking at a first display device of the one or more display devices and the determination that the user is not looking at the one or more displays devices is based on at least one of a gaze location of the user, a head position of the user, a body position of the user, and image data captured at a forward-facing camera of the head-wearable device.

(A12) In some embodiments of any of A1-A11, the one or more display devices include at least one of a smartphone, a display monitor, a personal computer, a television set, a smart watch, and a tablet.

(B1) In accordance with some embodiments, a non-transitory computer readable storage medium includes executable instructions that, when executed by a computing device (e.g., the head-wearable device 110, the at least one electronic device 120A-120D, and/or the other processing device), cause the computing device to perform actions while a head-wearable device (e.g., the head-wearable device 110), worn by a user (e.g., the user 105), is communicatively coupled to one or more display devices (e.g., the at least one electronic device 120A-120D). The instructions cause a first display device (e.g., the second electronic device 120B) of the one or more display devices to display a user interface (e.g., the UI 130). The instructions further cause the computing device to, in response to a switch input (e.g., the first gesture 171), performed by the user and detected at the head-wearable device: (i) cause the first display device to cease displaying the user interface and (ii) cause a second display device (e.g., the third electronic device 120C) to display the user interface. The switch input indicates the second display device of the one or more display devices.

(B2) In some embodiments of B1, the instructions further cause the computing device to, in response to another switch input, indicating a third display device (e.g., the wrist-wearable device 120D) of the one or more display devices: (i) cause the first display device to cease displaying the user interface and (ii) cause the third display device to display the user interface.

(B3) In some embodiments of any of B1-B2, the instructions further cause the computing device to, in response to the switch input, indicating the second display device of the one or more display devices, and before causing the first display device to cease displaying the user interface and causing the second display device to display the user interface: (i) cause the first display device to display a first portion of the user interface and (ii) cause the second display device to display a second portion of the user interface. The user interface appears to slide from the first display device to the second display device.

(B4) In some embodiments of any of B1-B3, the instructions further cause the computing device to, in response to a long switch input, indicating a fourth display device of the one or more display devices: (i) at first point in time, cause the first display device to cease displaying the user interface and cause the second display device to display the user interface, and (ii) at second point in time, after the first point in time, cause the second display device to cease displaying the user interface and cause the fourth display device to display the user interface. The second display device is between the first display device and the fourth display device.

(B5) In some embodiments of any of B1-B4, the instructions further cause the computing device to (i) before causing the first display device to cease displaying the user interface and causing the second display device to display the user interface, cause the first display device to display a first portion of the user interface and cause the second display device to display a second portion of the user interface, and (ii) before causing the second display device to cease displaying the user interface and causing the fourth display device to display the user interface, cause the second display device to display a third portion of the user interface and cause the fourth display device to display a fourth portion of the user interface. The user interface appears to slide from the first display device to the second display device and onto the fourth display device.

(B6) In some embodiments of any of B1-B5, the switch input is at least one of a hand gesture, a gaze gesture, a voice command, and a button press.

(B7) In some embodiments of any of B1-B6, the one or more display devices include at least one of a smartphone, a display monitor, a personal computer, a television set, a smart watch, and a tablet.

(C1) In accordance with some embodiments, an XR system includes a head-wearable device, which includes a first sensor (e.g., an eye-tracking camera and/or an IMU) and a first imaging device (e.g., a camera), and a wrist-wearable device, which is communicatively coupled to the head-wearable device and includes a second sensor (e.g., an IMU and/or an EMG sensor) and a second imaging device. The XR system is configured to, while the head-wearable device and the wrist-wearable device are worn by a user, and while a video call is being performed between the user and at least one other user, cause the first imaging device of the head-wearable device to capture first image data (e.g., video and audio data) to be used during the video call. The XR system is further configured to receive first sensor data (e.g., the user looks at the watch to use a camera on the watch in selfie mode) from the first sensor of the head-wearable device and second sensor data (e.g., the user lifts the wrist-wearable device to use the camera on the watch in selfie mode) from the second sensor of the wrist-wearable device. The XR system is further configured to, in accordance with a determination that a comparison of the first sensor data and the second sensor data indicates that a field of view of the user is not directed at the wrist-wearable device, cause the first imaging device to continue to capture the first image data to be used during the video call. The XR system is further configured to, in accordance with a determination that the comparison of the first sensor data and the second sensor data indicates that the field of view of the user is directed at the wrist-wearable device, cause the second imaging device to capture second image data to be used during the video call.

(C2) In some embodiments of C1, the XR system is further configured to, while capturing the second image data at the second imaging device of the wrist-wearable device, receive third sensor data from the first sensor at the head-wearable device. The XR system is further configured to display an indication at the head-wearable device and/or the wrist-wearable device, the indication including one or more options for selecting a respective imaging device. The XR system is further configured to, in response to receiving a user input selecting a first option from the indication, cause a third imaging device of the head-wearable device to capture third image data to be used during the video call. In some embodiments, the indication prompts the user to switch their camera from the second imaging device at the wrist-wearable device to the third imaging device at the head-wearable device.

(C3) In some embodiments of any of C1-C2, the indication is a first indication, and the XR system is further configured to, while capturing the third image data at the third imaging device of the head-wearable device, receive fourth sensor data from the first sensor at the head-wearable device. The XR system is further configured to display a second indication at the head-wearable device and/or the wrist-wearable device, the second indication including one or more options for selecting another respective imaging device. The XR system is further configured to, in response to receiving a second user input selecting a second option from the second indication, continue to cause the third imaging device of the head-wearable device to capture the third image data to be used during the video call.

(C4) In some embodiments of any of C1-C3, the indication is a first indication, and the XR system is further configured to, while capturing the third image data at the third imaging device of the head-wearable device, receive fifth sensor data from the first sensor at the head-wearable device. The XR system is further configured to, based on the fifth set of sensor data, select a fourth imaging device at the wrist-wearable device (e.g., a camera on a rear side of the wrist-wearable device) such that the fourth imaging device at the wrist-wearable device captures a fourth image data to be used during the video call. The XR system is further configured display a third indication at the head-wearable device and/or wrist-wearable device, the third indication including one or more options for selecting yet another respective imaging device. The XR system is further configured to, in response to receiving a third user input selecting a third option from the third indication, causing the first imaging device of the head-wearable device or the second imaging device of the wrist-wearable device to capture respective image data to be used during the video call.

(C5) In some embodiments of any of C1-C4, the XR system is further configured to, while causing the second imaging device to capture the second image data to be used during the video call, enhance the second image data using a video stabilization technique and a video auto-leveling technique.

(C6) In some embodiments of C1-C5, the first sensor at the head-wearable device is an IMU.

(C7) In some embodiments of C1-C6, the second sensor at the wrist-wearable device is one of an IMU and an EMG sensor.

(D1) In accordance with some embodiments, an electronic device including one or more cameras, one or more displays, and one or more programs. The one or more programs are stored in memory and configured to be executed by one or more processors, the one or more programs including instructions for performing operations corresponding to any of A1-C7.

(E1) In accordance with some embodiments, a non-transitory computer readable storage medium including instructions that, when executed by a computing device, cause the computing device to perform operations corresponding to any of A1-C7.

(F1) In accordance with some embodiments, a method of comprising operations that correspond to any of A1-C7.

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device 400, a head-wearable device, an HIPD 600, a smart textile-based garment 700, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

A gaze gesture, as described herein, can include an eye movement and/or a head movement indicative of a location of a gaze of the user, an implied location of the gaze of the user, and/or an approximated location of the gaze of the user, in the surrounding environment, the virtual environment, and/or the displayed user interface. The gaze gesture can be detected and determined based on (i) eye movements captured by one or more eye-tracking cameras (e.g., one or more cameras positioned to capture image data of one or both eyes of the user) and/or (ii) a combination of a head orientation of the user (e.g., based on head and/or body movements) and image data from a point-of-view camera (e.g., a forward-facing camera of the head-wearable device). The head orientation is determined based on IMU data captured by an IMU sensor of the head-wearable device. In some embodiments, the IMU data indicates a pitch angle (e.g., the user nodding their head up-and-down) and a yaw angle (e.g., the user shaking their head side-to-side). The head-orientation can then be mapped onto the image data captured from the point-of-view camera to determine the gaze gesture. For example, a quadrant of the image data that the user is looking at can be determined based on whether the pitch angle and the yaw angle are negative or positive (e.g., a positive pitch angle and a positive yaw angle indicate that the gaze gesture is directed toward a top-left quadrant of the image data, a negative pitch angle and a negative yaw angle indicate that the gaze gesture is directed toward a bottom-right quadrant of the image data, etc.). In some embodiments, the IMU data and the image data used to determine the gaze are captured at a same time, and/or the IMU data and the image data used to determine the gaze are captured at offset times (e.g., the IMU data is captured at a predetermined time (e.g., 0.01 seconds to 0.5 seconds) after the image data is captured). In some embodiments, the head-wearable device includes a hardware clock to synchronize the capture of the IMU data and the image data. In some embodiments, object segmentation and/or image detection methods are applied to the quadrant of the image data that the user is looking at.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) artificial-reality (AR) applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example AR Systems

FIGS. 3A and 3B illustrate example artificial-reality systems, in accordance with some embodiments. FIG. 3A shows a first AR system 300a and first example user interactions using a wrist-wearable device 400, a head-wearable device (e.g., AR device 500), and/or a handheld intermediary processing device (HIPD) 600. FIG. 3B shows a second AR system 300b and second example user interactions using a wrist-wearable device 400, AR device 500, and/or an HIPD 600. As the skilled artisan will appreciate upon reading the descriptions provided herein, the above-example AR systems (described in detail below) can perform various functions and/or operations described above with reference to FIGS. 1A-2E.

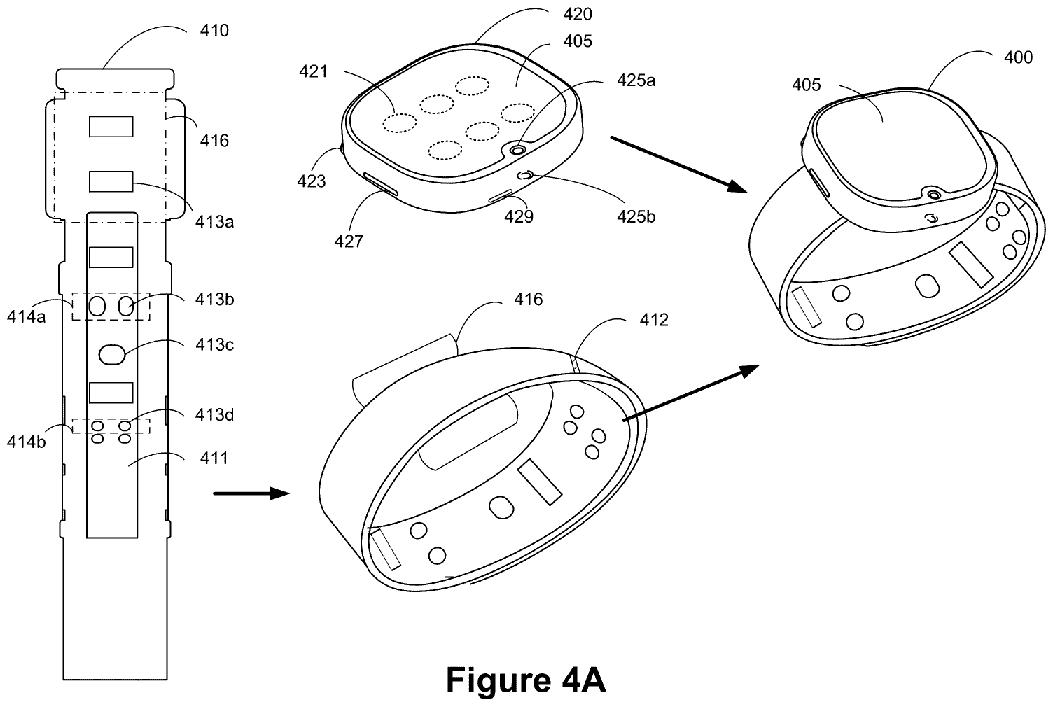

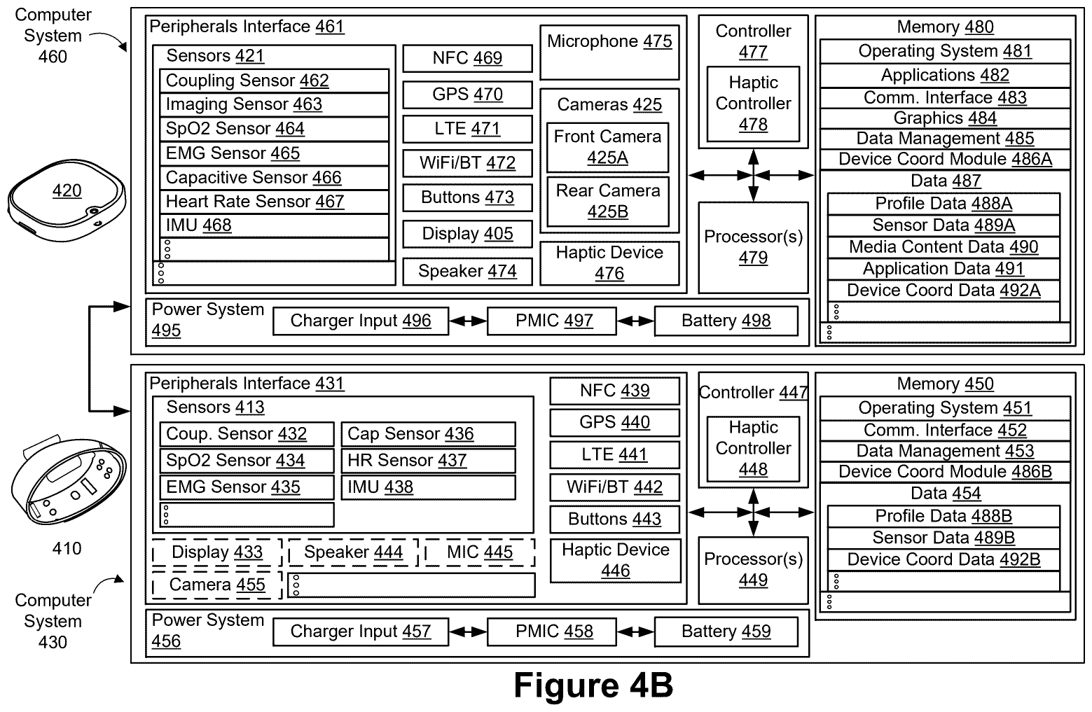

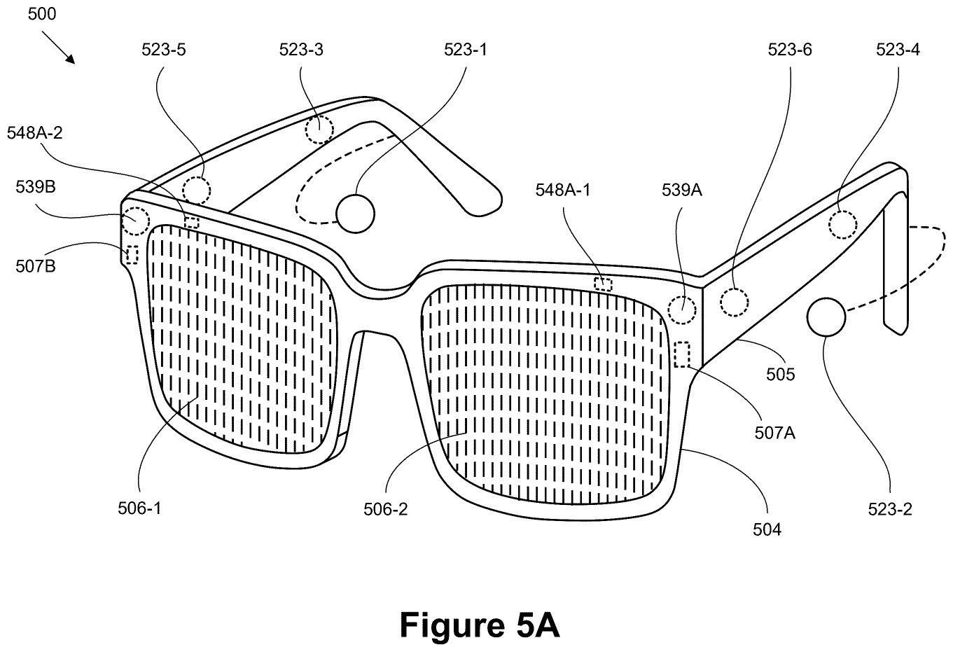

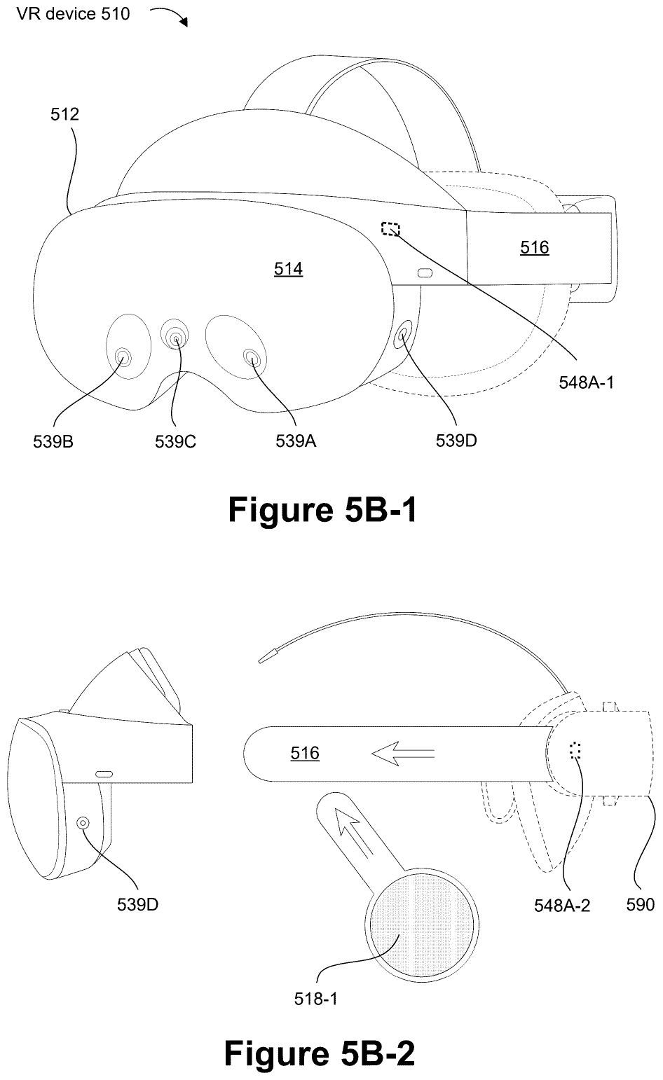

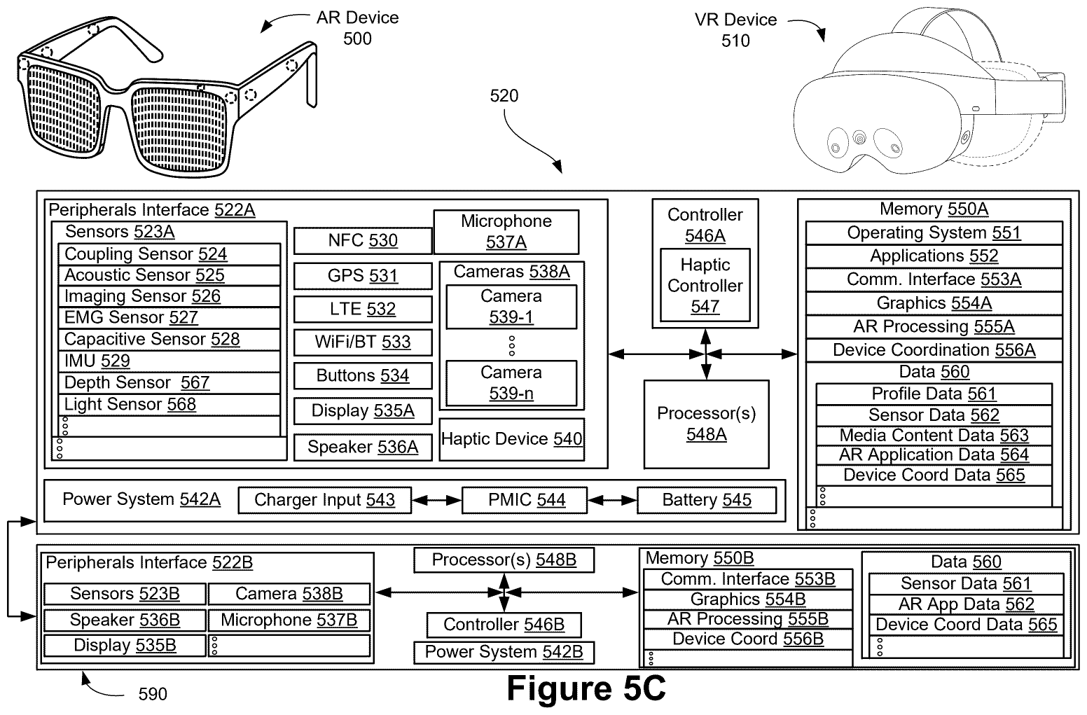

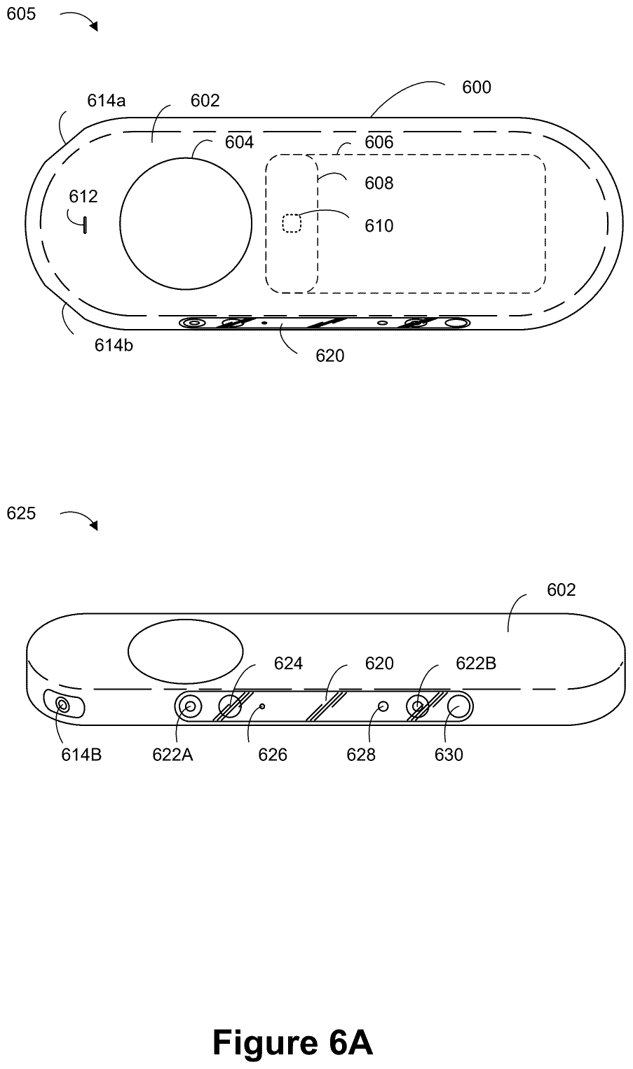

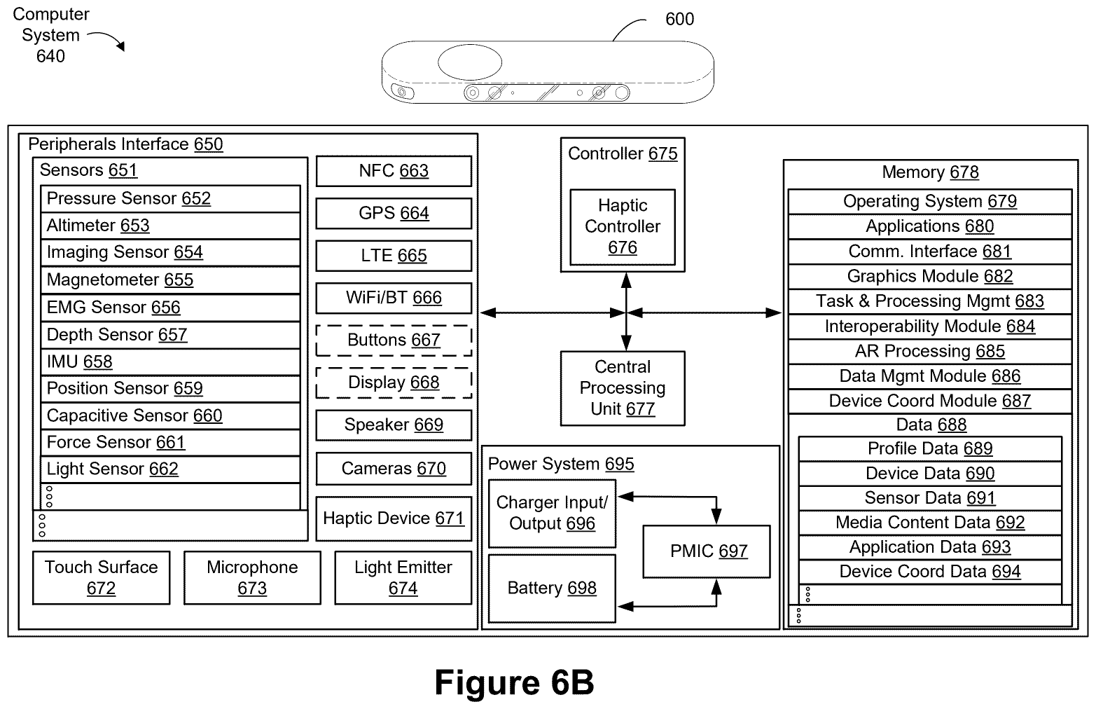

The wrist-wearable device 400 and its constituent components are described below in reference to FIGS. 4A-4B, the head-wearable devices and their constituent components are described below in reference to FIGS. 5A-5D, and the HIPD 600 and its constituent components are described below in reference to FIGS. 6A-6B. The wrist-wearable device 400, the head-wearable devices, and/or the HIPD 600 can communicatively couple via a network 325 (e.g., cellular, near field, Wi-Fi, personal area network, wireless LAN, etc.). Additionally, the wrist-wearable device 400, the head-wearable devices, and/or the HIPD 600 can also communicatively couple with one or more servers 330, computers 340 (e.g., laptops, computers, etc.), mobile devices 350 (e.g., smartphones, tablets, etc.), and/or other electronic devices via the network 325 (e.g., cellular, near field, Wi-Fi, personal area network, wireless LAN, etc.) Similarly, a smart textile-based garment, when used, can also communicatively couple with the wrist-wearable device 400, the head-wearable devices, the HIPD 600, the one or more servers 330, the computers 340, the mobile devices 350, and/or other electronic devices via the network 325.

Turning to FIG. 3A, a user 302 is shown wearing the wrist-wearable device 400 and the AR device 500, and having the HIPD 600 on their desk. The wrist-wearable device 400, the AR device 500, and the HIPD 600 facilitate user interaction with an AR environment. In particular, as shown by the first AR system 300a, the wrist-wearable device 400, the AR device 500, and/or the HIPD 600 cause presentation of one or more avatars 304, digital representations of contacts 306, and virtual objects 308. As discussed below, the user 302 can interact with the one or more avatars 304, digital representations of the contacts 306, and virtual objects 308 via the wrist-wearable device 400, the AR device 500, and/or the HIPD 600.

The user 302 can use any of the wrist-wearable device 400, the AR device 500, and/or the HIPD 600 to provide user inputs. For example, the user 302 can perform one or more hand gestures that are detected by the wrist-wearable device 400 (e.g., using one or more EMG sensors and/or IMUs, described below in reference to FIGS. 4A-4B) and/or AR device 500 (e.g., using one or more image sensors or cameras, described below in reference to FIGS. 5A-5B) to provide a user input. Alternatively, or additionally, the user 302 can provide a user input via one or more touch surfaces of the wrist-wearable device 400, the AR device 500, and/or the HIPD 600, and/or voice commands captured by a microphone of the wrist-wearable device 400, the AR device 500, and/or the HIPD 600. In some embodiments, the wrist-wearable device 400, the AR device 500, and/or the HIPD 600 include a digital assistant to help the user in providing a user input (e.g., completing a sequence of operations, suggesting different operations or commands, providing reminders, confirming a command). In some embodiments, the user 302 can provide a user input via one or more facial gestures and/or facial expressions. For example, cameras of the wrist-wearable device 400, the AR device 500, and/or the HIPD 600 can track the user 302's eyes for navigating a user interface.

The wrist-wearable device 400, the AR device 500, and/or the HIPD 600 can operate alone or in conjunction to allow the user 302 to interact with the AR environment. In some embodiments, the HIPD 600 is configured to operate as a central hub or control center for the wrist-wearable device 400, the AR device 500, and/or another communicatively coupled device.

For example, the user 302 can provide an input to interact with the AR environment at any of the wrist-wearable device 400, the AR device 500, and/or the HIPD 600, and the HIPD 600 can identify one or more back-end and front-end tasks to cause the performance of the requested interaction and distribute instructions to cause the performance of the one or more back-end and front-end tasks at the wrist-wearable device 400, the AR device 500, and/or the HIPD 600. In some embodiments, a back-end task is a background-processing task that is not perceptible by the user (e.g., rendering content, decompression, compression, etc.), and a front-end task is a user-facing task that is perceptible to the user (e.g., presenting information to the user, providing feedback to the user, etc.)). As described below in reference to FIGS. 6A-6B, the HIPD 600 can perform the back-end tasks and provide the wrist-wearable device 400 and/or the AR device 500 operational data corresponding to the performed back-end tasks such that the wrist-wearable device 400 and/or the AR device 500 can perform the front-end tasks. In this way, the HIPD 600, which has more computational resources and greater thermal headroom than the wrist-wearable device 400 and/or the AR device 500, performs computationally intensive tasks and reduces the computer resource utilization and/or power usage of the wrist-wearable device 400 and/or the AR device 500.

In the example shown by the first AR system 300a, the HIPD 600 identifies one or more back-end tasks and front-end tasks associated with a user request to initiate an AR video call with one or more other users (represented by the avatar 304 and the digital representation of the contact 306) and distributes instructions to cause the performance of the one or more back-end tasks and front-end tasks. In particular, the HIPD 600 performs back-end tasks for processing and/or rendering image data (and other data) associated with the AR video call and provides operational data associated with the performed back-end tasks to the AR device 500 such that the AR device 500 performs front-end tasks for presenting the AR video call (e.g., presenting the avatar 304 and the digital representation of the contact 306).

In some embodiments, the HIPD 600 can operate as a focal or anchor point for causing the presentation of information. This allows the user 302 to be generally aware of where information is presented. For example, as shown in the first AR system 300a, the avatar 304 and the digital representation of the contact 306 are presented above the HIPD 600. In particular, the HIPD 600 and the AR device 500 operate in conjunction to determine a location for presenting the avatar 304 and the digital representation of the contact 306. In some embodiments, information can be presented within a predetermined distance from the HIPD 600 (e.g., within five meters). For example, as shown in the first AR system 300a, virtual object 308 is presented on the desk some distance from the HIPD 600. Similar to the above example, the HIPD 600 and the AR device 500 can operate in conjunction to determine a location for presenting the virtual object 308. Alternatively, in some embodiments, presentation of information is not bound by the HIPD 600. More specifically, the avatar 304, the digital representation of the contact 306, and the virtual object 308 do not have to be presented within a predetermined distance of the HIPD 600.

User inputs provided at the wrist-wearable device 400, the AR device 500, and/or the HIPD 600 are coordinated such that the user can use any device to initiate, continue, and/or complete an operation. For example, the user 302 can provide a user input to the AR device 500 to cause the AR device 500 to present the virtual object 308 and, while the virtual object 308 is presented by the AR device 500, the user 302 can provide one or more hand gestures via the wrist-wearable device 400 to interact and/or manipulate the virtual object 308.

FIG. 3B shows the user 302 wearing the wrist-wearable device 400 and the AR device 500, and holding the HIPD 600. In the second AR system 300b, the wrist-wearable device 400, the AR device 500, and/or the HIPD 600 are used to receive and/or provide one or more messages to a contact of the user 302. In particular, the wrist-wearable device 400, the AR device 500, and/or the HIPD 600 detect and coordinate one or more user inputs to initiate a messaging application and prepare a response to a received message via the messaging application.

In some embodiments, the user 302 initiates, via a user input, an application on the wrist-wearable device 400, the AR device 500, and/or the HIPD 600 that causes the application to initiate on at least one device. For example, in the second AR system 300b the user 302 performs a hand gesture associated with a command for initiating a messaging application (represented by messaging user interface 312); the wrist-wearable device 400 detects the hand gesture; and, based on a determination that the user 302 is wearing AR device 500, causes the AR device 500 to present a messaging user interface 312 of the messaging application. The AR device 500 can present the messaging user interface 312 to the user 302 via its display (e.g., as shown by user 302's field of view 310). In some embodiments, the application is initiated and can be run on the device (e.g., the wrist-wearable device 400, the AR device 500, and/or the HIPD 600) that detects the user input to initiate the application, and the device provides another device operational data to cause the presentation of the messaging application. For example, the wrist-wearable device 400 can detect the user input to initiate a messaging application, initiate and run the messaging application, and provide operational data to the AR device 500 and/or the HIPD 600 to cause presentation of the messaging application. Alternatively, the application can be initiated and run at a device other than the device that detected the user input. For example, the wrist-wearable device 400 can detect the hand gesture associated with initiating the messaging application and cause the HIPD 600 to run the messaging application and coordinate the presentation of the messaging application.

Further, the user 302 can provide a user input provided at the wrist-wearable device 400, the AR device 500, and/or the HIPD 600 to continue and/or complete an operation initiated at another device. For example, after initiating the messaging application via the wrist-wearable device 400 and while the AR device 500 presents the messaging user interface 312, the user 302 can provide an input at the HIPD 600 to prepare a response (e.g., shown by the swipe gesture performed on the HIPD 600). The user 302's gestures performed on the HIPD 600 can be provided and/or displayed on another device. For example, the user 302's swipe gestures performed on the HIPD 600 are displayed on a virtual keyboard of the messaging user interface 312 displayed by the AR device 500.

In some embodiments, the wrist-wearable device 400, the AR device 500, the HIPD 600, and/or other communicatively coupled devices can present one or more notifications to the user 302. The notification can be an indication of a new message, an incoming call, an application update, a status update, etc. The user 302 can select the notification via the wrist-wearable device 400, the AR device 500, or the HIPD 600 and cause presentation of an application or operation associated with the notification on at least one device. For example, the user 302 can receive a notification that a message was received at the wrist-wearable device 400, the AR device 500, the HIPD 600, and/or other communicatively coupled device and provide a user input at the wrist-wearable device 400, the AR device 500, and/or the HIPD 600 to review the notification, and the device detecting the user input can cause an application associated with the notification to be initiated and/or presented at the wrist-wearable device 400, the AR device 500, and/or the HIPD 600.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 500 can present to the user 302 game application data and the HIPD 600 can use a controller to provide inputs to the game. Similarly, the user 302 can use the wrist-wearable device 400 to initiate a camera of the AR device 500, and the user can use the wrist-wearable device 400, the AR device 500, and/or the HIPD 600 to manipulate the image capture (e.g., zoom in or out, apply filters, etc.) and capture image data.

Having discussed example AR systems, devices for interacting with such AR systems, and other computing systems more generally, will now be discussed in greater detail below. Some definitions of devices and components that can be included in some or all of the example devices discussed below are defined here for ease of reference. A skilled artisan will appreciate that certain types of the components described below may be more suitable for a particular set of devices, and less suitable for a different set of devices. But subsequent reference to the components defined here should be considered to be encompassed by the definitions provided.

In some embodiments discussed below example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

### Example Wrist-Wearable Devices

FIGS. 4A and 4B illustrate an example wrist-wearable device 400, in accordance with some embodiments. The wrist-wearable device 400 is an instance of the wrist-wearable device 120D and the wrist-wearable device 220 described in reference to FIGS. 1A-1K and FIGS. 2A-2E, respectively, herein, such that the wrist-wearable devices should be understood to have the features of the wrist-wearable device 400 and vice versa. FIG. 4A illustrates components of the wrist-wearable device 400, which can be used individually or in combination, including combinations that include other electronic devices and/or electronic components.

FIG. 4A shows a wearable band 410 and a watch body 420 (or capsule) being coupled, as discussed below, to form the wrist-wearable device 400. The wrist-wearable device 400 can perform various functions and/or operations associated with navigating through user interfaces and selectively opening applications, as well as the functions and/or operations described above with reference to FIGS. 1A-2E.

As will be described in more detail below, operations executed by the wrist-wearable device 400 can include (i) presenting content to a user (e.g., displaying visual content via a display 405); (ii) detecting (e.g., sensing) user input (e.g., sensing a touch on peripheral button 423 and/or at a touch screen of the display 405, a hand gesture detected by sensors (e.g., biopotential sensors)); (iii) sensing biometric data via one or more sensors 413 (e.g., neuromuscular signals, heart rate, temperature, sleep, etc.); messaging (e.g., text, speech, video, etc.); image capture via one or more imaging devices or cameras 425; wireless communications (e.g., cellular, near field, Wi-Fi, personal area network, etc.); location determination; financial transactions; providing haptic feedback; alarms; notifications; biometric authentication; health monitoring; sleep monitoring.

The above-example functions can be executed independently in the watch body 420, independently in the wearable band 410, and/or via an electronic communication between the watch body 420 and the wearable band 410. In some embodiments, functions can be executed on the wrist-wearable device 400 while an AR environment is being presented (e.g., via one of the AR systems 300a and 300b). As the skilled artisan will appreciate upon reading the descriptions provided herein, the novel wearable devices described herein can be used with other types of AR environments.

The wearable band 410 can be configured to be worn by a user such that an inner (or inside) surface of the wearable structure 411 of the wearable band 410 is in contact with the user's skin. When worn by a user, sensors 413 contact the user's skin. The sensors 413 can sense biometric data such as a user's heart rate, saturated oxygen level, temperature, sweat level, neuromuscular signal sensors, or a combination thereof. The sensors 413 can also sense data about a user's environment, including a user's motion, altitude, location, orientation, gait, acceleration, position, or a combination thereof. In some embodiments, the sensors 413 are configured to track a position and/or motion of the wearable band 410. The one or more sensors 413 can include any of the sensors defined above and/or discussed below with respect to FIG. 4B.

The one or more sensors 413 can be distributed on an inside and/or an outside surface of the wearable band 410. In some embodiments, the one or more sensors 413 are uniformly spaced along the wearable band 410. Alternatively, in some embodiments, the one or more sensors 413 are positioned at distinct points along the wearable band 410. As shown in FIG. 4A, the one or more sensors 413 can be the same or distinct. For example, in some embodiments, the one or more sensors 413 can be shaped as a pill (e.g., sensor 413a), an oval, a circle a square, an oblong (e.g., sensor 413c) and/or any other shape that maintains contact with the user's skin (e.g., such that neuromuscular signal and/or other biometric data can be accurately measured at the user's skin). In some embodiments, the one or more sensors 413 are aligned to form pairs of sensors (e.g., for sensing neuromuscular signals based on differential sensing within each respective sensor). For example, sensor 413b is aligned with an adjacent sensor to form sensor pair 414a and sensor 413d is aligned with an adjacent sensor to form sensor pair 414b. In some embodiments, the wearable band 410 does not have a sensor pair. Alternatively, in some embodiments, the wearable band 410 has a predetermined number of sensor pairs (one pair of sensors, three pairs of sensors, four pairs of sensors, six pairs of sensors, sixteen pairs of sensors, etc.).

The wearable band 410 can include any suitable number of sensors 413. In some embodiments, the number and arrangements of sensors 413 depend on the particular application for which the wearable band 410 is used. For instance, a wearable band 410 configured as an armband, wristband, or chest-band may include a plurality of sensors 413 with different number of sensors 413 and different arrangement for each use case, such as medical use cases, compared to gaming or general day-to-day use cases.

In accordance with some embodiments, the wearable band 410 further includes an electrical ground electrode and a shielding electrode. The electrical ground and shielding electrodes, like the sensors 413, can be distributed on the inside surface of the wearable band 410 such that they contact a portion of the user's skin. For example, the electrical ground and shielding electrodes can be at an inside surface of coupling mechanism 416 or an inside surface of a wearable structure 411. The electrical ground and shielding electrodes can be formed and/or use the same components as the sensors 413. In some embodiments, the wearable band 410 includes more than one electrical ground electrode and more than one shielding electrode.

The sensors 413 can be formed as part of the wearable structure 411 of the wearable band 410. In some embodiments, the sensors 413 are flush or substantially flush with the wearable structure 411 such that they do not extend beyond the surface of the wearable structure 411. While flush with the wearable structure 411, the sensors 413 are still configured to contact the user's skin (e.g., via a skin-contacting surface). Alternatively, in some embodiments, the sensors 413 extend beyond the wearable structure 411 a predetermined distance (e.g., 0.1 mm to 2 mm) to make contact and depress into the user's skin. In some embodiments, the sensors 413 are coupled to an actuator (not shown) configured to adjust an extension height (e.g., a distance from the surface of the wearable structure 411) of the sensors 413 such that the sensors 413 make contact and depress into the user's skin. In some embodiments, the actuators adjust the extension height between 0.01 mm to 1.2 mm. This allows the user to customize the positioning of the sensors 413 to improve the overall comfort of the wearable band 410 when worn while still allowing the sensors 413 to contact the user's skin. In some embodiments, the sensors 413 are indistinguishable from the wearable structure 411 when worn by the user.

The wearable structure 411 can be formed of an elastic material, elastomers, etc., configured to be stretched and fitted to be worn by the user. In some embodiments, the wearable structure 411 is a textile or woven fabric. As described above, the sensors 413 can be formed as part of a wearable structure 411. For example, the sensors 413 can be molded into the wearable structure 411 or be integrated into a woven fabric (e.g., the sensors 413 can be sewn into the fabric and mimic the pliability of fabric (e.g., the sensors 413 can be constructed from a series of woven strands of fabric)).

The wearable structure 411 can include flexible electronic connectors that interconnect the sensors 413, the electronic circuitry, and/or other electronic components (described below in reference to FIG. 4B) that are enclosed in the wearable band 410. In some embodiments, the flexible electronic connectors are configured to interconnect the sensors 413, the electronic circuitry, and/or other electronic components of the wearable band 410 with respective sensors and/or other electronic components of another electronic device (e.g., watch body 420). The flexible electronic connectors are configured to move with the wearable structure 411 such that the user adjustment to the wearable structure 411 (e.g., resizing, pulling, folding, etc.) does not stress or strain the electrical coupling of components of the wearable band 410.

As described above, the wearable band 410 is configured to be worn by a user. In particular, the wearable band 410 can be shaped or otherwise manipulated to be worn by a user. For example, the wearable band 410 can be shaped to have a substantially circular shape such that it can be configured to be worn on the user's lower arm or wrist. Alternatively, the wearable band 410 can be shaped to be worn on another body part of the user, such as the user's upper arm (e.g., around a bicep), forearm, chest, legs, etc. The wearable band 410 can include a retaining mechanism 412 (e.g., a buckle, a hook and loop fastener, etc.) for securing the wearable band 410 to the user's wrist or other body part. While the wearable band 410 is worn by the user, the sensors 413 sense data (referred to as sensor data) from the user's skin. In particular, the sensors 413 of the wearable band 410 obtain (e.g., sense and record) neuromuscular signals.

The sensed data (e.g., sensed neuromuscular signals) can be used to detect and/or determine the user's intention to perform certain motor actions. In particular, the sensors 413 sense and record neuromuscular signals from the user as the user performs muscular activations (e.g., movements, gestures, etc.). The detected and/or determined motor actions (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 405 of the wrist-wearable device 400 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 413 can be used to provide a user with an enhanced interaction with a physical object (e.g., devices communicatively coupled with the wearable band 410) and/or a virtual object in an artificial-reality application generated by an artificial-reality system (e.g., user interface objects presented on the display 405 or another computing device (e.g., a smartphone)).

In some embodiments, the wearable band 410 includes one or more haptic devices 446 (FIG. 4B; e.g., a vibratory haptic actuator) that are configured to provide haptic feedback (e.g., a cutaneous and/or kinesthetic sensation, etc.) to the user's skin. The sensors 413, and/or the haptic devices 446 can be configured to operate in conjunction with multiple applications including, without limitation, health monitoring, social media, games, and artificial reality (e.g., the applications associated with artificial reality).

The wearable band 410 can also include coupling mechanism 416 (e.g., a cradle or a shape of the coupling mechanism can correspond to shape of the watch body 420 of the wrist-wearable device 400) for detachably coupling a capsule (e.g., a computing unit) or watch body 420 (via a coupling surface of the watch body 420) to the wearable band 410. In particular, the coupling mechanism 416 can be configured to receive a coupling surface proximate to the bottom side of the watch body 420 (e.g., a side opposite to a front side of the watch body 420 where the display 405 is located), such that a user can push the watch body 420 downward into the coupling mechanism 416 to attach the watch body 420 to the coupling mechanism 416. In some embodiments, the coupling mechanism 416 can be configured to receive a top side of the watch body 420 (e.g., a side proximate to the front side of the watch body 420 where the display 405 is located) that is pushed upward into the cradle, as opposed to being pushed downward into the coupling mechanism 416. In some embodiments, the coupling mechanism 416 is an integrated component of the wearable band 410 such that the wearable band 410 and the coupling mechanism 416 are a single unitary structure. In some embodiments, the coupling mechanism 416 is a type of frame or shell that allows the watch body 420 coupling surface to be retained within or on the wearable band 410 coupling mechanism 416 (e.g., a cradle, a tracker band, a support base, a clasp, etc.).

The coupling mechanism 416 can allow for the watch body 420 to be detachably coupled to the wearable band 410 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 420 to the wearable band 410 and to decouple the watch body 420 from the wearable band 410. For example, a user can twist, slide, turn, push, pull, or rotate the watch body 420 relative to the wearable band 410, or a combination thereof, to attach the watch body 420 to the wearable band 410 and to detach the watch body 420 from the wearable band 410. Alternatively, as discussed below, in some embodiments, the watch body 420 can be decoupled from the wearable band 410 by actuation of the release mechanism 429.

The wearable band 410 can be coupled with a watch body 420 to increase the functionality of the wearable band 410 (e.g., converting the wearable band 410 into a wrist-wearable device 400, adding an additional computing unit and/or battery to increase computational resources and/or a battery life of the wearable band 410, adding additional sensors to improve sensed data, etc.). As described above, the wearable band 410 (and the coupling mechanism 416) is configured to operate independently (e.g., execute functions independently) from watch body 420. For example, the coupling mechanism 416 can include one or more sensors 413 that contact a user's skin when the wearable band 410 is worn by the user and provide sensor data for determining control commands.

A user can detach the watch body 420 (or capsule) from the wearable band 410 in order to reduce the encumbrance of the wrist-wearable device 400 to the user. For embodiments in which the watch body 420 is removable, the watch body 420 can be referred to as a removable structure, such that in these embodiments the wrist-wearable device 400 includes a wearable portion (e.g., the wearable band 410) and a removable structure (the watch body 420).

Turning to the watch body 420, the watch body 420 can have a substantially rectangular or circular shape. The watch body 420 is configured to be worn by the user on their wrist or on another body part. More specifically, the watch body 420 is sized to be easily carried by the user, attached on a portion of the user's clothing, and/or coupled to the wearable band 410 (forming the wrist-wearable device 400). As described above, the watch body 420 can have a shape corresponding to the coupling mechanism 416 of the wearable band 410. In some embodiments, the watch body 420 includes a single release mechanism 429 or multiple release mechanisms (e.g., two release mechanisms 429 positioned on opposing sides of the watch body 420, such as spring-loaded buttons) for decoupling the watch body 420 and the wearable band 410. The release mechanism 429 can include, without limitation, a button, a knob, a plunger, a handle, a lever, a fastener, a clasp, a dial, a latch, or a combination thereof.

A user can actuate the release mechanism 429 by pushing, turning, lifting, depressing, shifting, or performing other actions on the release mechanism 429. Actuation of the release mechanism 429 can release (e.g., decouple) the watch body 420 from the coupling mechanism 416 of the wearable band 410, allowing the user to use the watch body 420 independently from wearable band 410, and vice versa. For example, decoupling the watch body 420 from the wearable band 410 can allow the user to capture images using rear-facing camera 425B. Although the coupling mechanism 416 is shown positioned at a corner of watch body 420, the release mechanism 429 can be positioned anywhere on watch body 420 that is convenient for the user to actuate. In addition, in some embodiments, the wearable band 410 can also include a respective release mechanism for decoupling the watch body 420 from the coupling mechanism 416. In some embodiments, the release mechanism 429 is optional and the watch body 420 can be decoupled from the coupling mechanism 416 as described above (e.g., via twisting, rotating, etc.).

The watch body 420 can include one or more peripheral buttons 423 and 427 for performing various operations at the watch body 420. For example, the peripheral buttons 423 and 427 can be used to turn on or wake (e.g., transition from a sleep state to an active state) the display 405, unlock the watch body 420, increase or decrease a volume, increase or decrease brightness, interact with one or more applications, interact with one or more user interfaces, etc. Additionally, or alternatively, in some embodiments, the display 405 operates as a touch screen and allows the user to provide one or more inputs for interacting with the watch body 420.

In some embodiments, the watch body 420 includes one or more sensors 421. The sensors 421 of the watch body 420 can be the same or distinct from the sensors 413 of the wearable band 410. The sensors 421 of the watch body 420 can be distributed on an inside and/or an outside surface of the watch body 420. In some embodiments, the sensors 421 are configured to contact a user's skin when the watch body 420 is worn by the user. For example, the sensors 421 can be placed on the bottom side of the watch body 420 and the coupling mechanism 416 can be a cradle with an opening that allows the bottom side of the watch body 420 to directly contact the user's skin. Alternatively, in some embodiments, the watch body 420 does not include sensors that are configured to contact the user's skin (e.g., including sensors internal and/or external to the watch body 420 that configured to sense data of the watch body 420 and the watch body 420's surrounding environment). In some embodiments, the sensors 413 are configured to track a position and/or motion of the watch body 420.

The watch body 420 and the wearable band 410 can share data using a wired communication method (e.g., a Universal Asynchronous Receiver/Transmitter (UART), a USB transceiver, etc.) and/or a wireless communication method (e.g., near field communication, Bluetooth, etc.). For example, the watch body 420 and the wearable band 410 can share data sensed by the sensors 413 and 421, as well as application- and device-specific information (e.g., active and/or available applications), output devices (e.g., display, speakers, etc.), input devices (e.g., touch screen, microphone, imaging sensors, etc.).

In some embodiments, the watch body 420 can include, without limitation, a front-facing camera 425A and/or a rear-facing camera 425B, sensors 421 (e.g., a biometric sensor, an IMU sensor, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 463; FIG. 4B), a touch sensor, a sweat sensor, etc.). In some embodiments, the watch body 420 can include one or more haptic devices 476 (FIG. 4B; a vibratory haptic actuator) that is configured to provide haptic feedback (e.g., a cutaneous and/or kinesthetic sensation, etc.) to the user. The sensors 421 and/or the haptic device 476 can also be configured to operate in conjunction with multiple applications including, without limitation, health-monitoring applications, social media applications, game applications, and artificial-reality applications (e.g., the applications associated with artificial reality).

As described above, the watch body 420 and the wearable band 410, when coupled, can form the wrist-wearable device 400. When coupled, the watch body 420 and wearable band 410 operate as a single device to execute functions (operations, detections, communications, etc.) described herein. In some embodiments, each device is provided with particular instructions for performing the one or more operations of the wrist-wearable device 400. For example, in accordance with a determination that the watch body 420 does not include neuromuscular signal sensors, the wearable band 410 can include alternative instructions for performing associated instructions (e.g., providing sensed neuromuscular signal data to the watch body 420 via a different electronic device). Operations of the wrist-wearable device 400 can be performed by the watch body 420 alone or in conjunction with the wearable band 410 (e.g., via respective processors and/or hardware components) and vice versa. In some embodiments, operations of the wrist-wearable device 400, the watch body 420, and/or the wearable band 410 can be performed in conjunction with one or more processors and/or hardware components of another communicatively coupled device (e.g., the HIPD 600; FIGS. 6A-6B).

As described below with reference to the block diagram of FIG. 4B, the wearable band 410 and/or the watch body 420 can each include independent resources required to independently execute functions. For example, the wearable band 410 and/or the watch body 420 can each include a power source (e.g., a battery), a memory, data storage, a processor (e.g., a central processing unit (CPU)), communications, a light source, and/or input/output devices.

FIG. 4B shows block diagrams of a computing system 430 corresponding to the wearable band 410, and a computing system 460 corresponding to the watch body 420, according to some embodiments. A computing system of the wrist-wearable device 400 includes a combination of components of the wearable band computing system 430 and the watch body computing system 460, in accordance with some embodiments.

The watch body 420 and/or the wearable band 410 can include one or more components shown in watch body computing system 460. In some embodiments, a single integrated circuit includes all or a substantial portion of the components of the watch body computing system 460 are included in a single integrated circuit. Alternatively, in some embodiments, components of the watch body computing system 460 are included in a plurality of integrated circuits that are communicatively coupled. In some embodiments, the watch body computing system 460 is configured to couple (e.g., via a wired or wireless connection) with the wearable band computing system 430, which allows the computing systems to share components, distribute tasks, and/or perform other operations described herein (individually or as a single device).

The watch body computing system 460 can include one or more processors 479, a controller 477, a peripherals interface 461, a power system 495, and memory (e.g., a memory 480), each of which are defined above and described in more detail below.

The power system 495 can include a charger input 496, a power-management integrated circuit (PMIC) 497, and a battery 498, each are which are defined above. In some embodiments, a watch body 420 and a wearable band 410 can have respective charger inputs (e.g., charger input 496 and 457), respective batteries (e.g., battery 498 and 459), and can share power with each other (e.g., the watch body 420 can power and/or charge the wearable band 410, and vice versa). Although watch body 420 and/or the wearable band 410 can include respective charger inputs, a single charger input can charge both devices when coupled. The watch body 420 and the wearable band 410 can receive a charge using a variety of techniques. In some embodiments, the watch body 420 and the wearable band 410 can use a wired charging assembly (e.g., power cords) to receive the charge. Alternatively, or in addition, the watch body 420 and/or the wearable band 410 can be configured for wireless charging. For example, a portable charging device can be designed to mate with a portion of watch body 420 and/or wearable band 410 and wirelessly deliver usable power to a battery of watch body 420 and/or wearable band 410. The watch body 420 and the wearable band 410 can have independent power systems (e.g., power system 495 and 456) to enable each to operate independently. The watch body 420 and wearable band 410 can also share power (e.g., one can charge the other) via respective PMICs (e.g., PMICs 497 and 458) that can share power over power and ground conductors and/or over wireless charging antennas.

In some embodiments, the peripherals interface 461 can include one or more sensors 421, many of which listed below are defined above. The sensors 421 can include one or more coupling sensors 462 for detecting when the watch body 420 is coupled with another electronic device (e.g., a wearable band 410). The sensors 421 can include imaging sensors 463 (one or more of the cameras 425 and/or separate imaging sensors 463 (e.g., thermal-imaging sensors)). In some embodiments, the sensors 421 include one or more SpO2 sensors 464. In some embodiments, the sensors 421 include one or more biopotential-signal sensors (e.g., EMG sensors 465, which may be disposed on a user-facing portion of the watch body 420 and/or the wearable band 410). In some embodiments, the sensors 421 include one or more capacitive sensors 466. In some embodiments, the sensors 421 include one or more heart rate sensors 467. In some embodiments, the sensors 421 include one or more IMUs 468. In some embodiments, one or more IMUs 468 can be configured to detect movement of a user's hand or other location that the watch body 420 is placed or held.

In some embodiments, the peripherals interface 461 includes an NFC component 469, a global-position system (GPS) component 470, a long-term evolution (LTE) component 471, and/or a Wi-Fi and/or Bluetooth communication component 472. In some embodiments, the peripherals interface 461 includes one or more buttons 473 (e.g., the peripheral buttons 423 and 427 in FIG. 4A), which, when selected by a user, cause operations to be performed at the watch body 420. In some embodiments, the peripherals interface 461 includes one or more indicators, such as a light emitting diode (LED), to provide a user with visual indicators (e.g., message received, low battery, an active microphone, and/or a camera, etc.).

The watch body 420 can include at least one display 405 for displaying visual representations of information or data to the user, including user-interface elements and/or three-dimensional (3D) virtual objects. The display can also include a touch screen for inputting user inputs, such as touch gestures, swipe gestures, and the like. The watch body 420 can include at least one speaker 474 and at least one microphone 475 for providing audio signals to the user and receiving audio input from the user. The user can provide user inputs through the microphone 475 and can also receive audio output from the speaker 474 as part of a haptic event provided by the haptic controller 478. The watch body 420 can include at least one camera 425, including a front-facing camera 425A and a rear-facing camera 425B. The cameras 425 can include ultra-wide-angle cameras, wide-angle cameras, fish-eye cameras, spherical cameras, telephoto cameras, a depth-sensing cameras, or other types of cameras.

The watch body computing system 460 can include one or more haptic controllers 478 and associated componentry (e.g., haptic devices 476) for providing haptic events at the watch body 420 (e.g., a vibrating sensation or audio output in response to an event at the watch body 420). The haptic controllers 478 can communicate with one or more haptic devices 476, such as electroacoustic devices, including a speaker of the one or more speakers 474 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 478 can provide haptic events to respective haptic actuators that are capable of being sensed by a user of the watch body 420. In some embodiments, the one or more haptic controllers 478 can receive input signals from an application of the applications 482.

In some embodiments, the computer system 430 and/or the computer system 460 can include memory 480, which can be controlled by a memory controller of the one or more controllers 477 and/or one or more processors 479. In some embodiments, software components stored in the memory 480 include one or more applications 482 configured to perform operations at the watch body 420. In some embodiments, the one or more applications 482 include games, word processors, messaging applications, calling applications, web browsers, social media applications, media streaming applications, financial applications, calendars, clocks, etc. In some embodiments, software components stored in the memory 480 include one or more communication interface modules 483 as defined above. In some embodiments, software components stored in the memory 480 include one or more graphics modules 484 for rendering, encoding, and/or decoding audio and/or visual data; and one or more data management modules 485 for collecting, organizing, and/or providing access to the data 487 stored in memory 480. In some embodiments, software components stored in the memory 480 include a device coordination module 486A, which is configured to allow presented information to seamless switch between a plurality of devices. In some embodiments, one or more of applications 482 and/or one or more modules can work in conjunction with one another to perform various tasks at the watch body 420.

In some embodiments, software components stored in the memory 480 can include one or more operating systems 481 (e.g., a Linux-based operating system, an Android operating system, etc.). The memory 480 can also include data 487. The data 487 can include profile data 488A, sensor data 489A, media content data 490, application data 491, and device coordination data 492A which stores data related to the performance of the features described above in reference to FIGS. 1A-2E.

It should be appreciated that the watch body computing system 460 is an example of a computing system within the watch body 420, and that the watch body 420 can have more or fewer components than shown in the watch body computing system 460, combine two or more components, and/or have a different configuration and/or arrangement of the components. The various components shown in watch body computing system 460 are implemented in hardware, software, firmware, or a combination thereof, including one or more signal processing and/or application-specific integrated circuits.

Turning to the wearable band computing system 430, one or more components that can be included in the wearable band 410 are shown. The wearable band computing system 430 can include more or fewer components than shown in the watch body computing system 460, combine two or more components, and/or have a different configuration and/or arrangement of some or all of the components. In some embodiments, all, or a substantial portion of the components of the wearable band computing system 430 are included in a single integrated circuit. Alternatively, in some embodiments, components of the wearable band computing system 430 are included in a plurality of integrated circuits that are communicatively coupled. As described above, in some embodiments, the wearable band computing system 430 is configured to couple (e.g., via a wired or wireless connection) with the watch body computing system 460, which allows the computing systems to share components, distribute tasks, and/or perform other operations described herein (individually or as a single device).

The wearable band computing system 430, similar to the watch body computing system 460, can include one or more processors 449, one or more controllers 447 (including one or more haptics controller 448), a peripherals interface 431 that can include one or more sensors 413 and other peripheral devices, power source (e.g., a power system 456), and memory (e.g., a memory 450) that includes an operating system (e.g., an operating system 451), data (e.g., data 454 including profile data 488B, sensor data 489B, device coordination data 492B, etc.), and one or more modules (e.g., a communications interface module 452, a data management module 453, a device coordination module 486B, etc.).

The one or more sensors 413 can be analogous to sensors 421 of the computer system 460 in light of the definitions above. For example, sensors 413 can include one or more coupling sensors 432, one or more SpO2 sensors 434, one or more EMG sensors 435, one or more capacitive sensors 436, one or more heart rate sensors 437, and one or more IMU sensors 438.

The peripherals interface 431 can also include other components analogous to those included in the peripheral interface 461 of the computer system 460, including an NFC component 439, a GPS component 440, an LTE component 441, a Wi-Fi and/or Bluetooth communication component 442, and/or one or more haptic devices 476 as described above in reference to peripherals interface 461. In some embodiments, the peripherals interface 431 includes one or more buttons 443, a display 433, a speaker 444, a microphone 445, and a camera 455. In some embodiments, the peripherals interface 431 includes one or more indicators, such as an LED.

It should be appreciated that the wearable band computing system 430 is an example of a computing system within the wearable band 410, and that the wearable band 410 can have more or fewer components than shown in the wearable band computing system 430, combine two or more components, and/or have a different configuration and/or arrangement of the components. The various components shown in wearable band computing system 430 can be implemented in one or a combination of hardware, software, and firmware, including one or more signal processing and/or application-specific integrated circuits.

The wrist-wearable device 400 with respect to FIG. 4A is an example of the wearable band 410 and the watch body 420 coupled, so the wrist-wearable device 400 will be understood to include the components shown and described for the wearable band computing system 430 and the watch body computing system 460. In some embodiments, wrist-wearable device 400 has a split architecture (e.g., a split mechanical architecture or a split electrical architecture) between the watch body 420 and the wearable band 410. In other words, all of the components shown in the wearable band computing system 430 and the watch body computing system 460 can be housed or otherwise disposed in a combined watch device 400, or within individual components of the watch body 420, wearable band 410, and/or portions thereof (e.g., a coupling mechanism 416 of the wearable band 410).

The techniques described above can be used with any device for sensing neuromuscular signals, including the arm-wearable devices of FIG. 4A-4B, but could also be used with other types of wearable devices for sensing neuromuscular signals (such as body-wearable or head-wearable devices that might have neuromuscular sensors closer to the brain or spinal column).

In some embodiments, a wrist-wearable device 400 can be used in conjunction with a head-wearable device described below (e.g., AR device 500 and VR device 510) and/or an HIPD 600, and the wrist-wearable device 400 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable device, attention will now be turned to example head-wearable devices, such AR device 500 and VR device 510.

### Example Head-Wearable Devices

FIGS. 5A, 5B-1, 5B-2, and 5C show example head-wearable devices, in accordance with some embodiments. Head-wearable devices can include, but are not limited to, AR devices 510 (e.g., AR or smart eyewear devices, such as smart glasses, smart monocles, smart contacts, etc.), VR devices 510 (e.g., VR headsets, head-mounted displays (HMD) s, etc.), or other ocularly coupled devices. The AR devices 500 and the VR devices 510 are instances of the head-wearable device 110 and the head-wearable device 210 described in reference to FIGS. 1A-1K and 2A-2E, respectively, herein, such that the head-wearable device should be understood to have the features of the AR devices 500 and/or the VR devices 510, and vice versa. The AR devices 500 and the VR devices 510 can perform various functions and/or operations associated with navigating through user interfaces and selectively opening applications, as well as the functions and/or operations described above with reference to FIGS. 1A-2E.

In some embodiments, an AR system (e.g., AR systems 300a and 300b; FIGS. 3A and 3B) includes an AR device 500 (as shown in FIG. 5A) and/or VR device 510 (as shown in FIGS. 5B-1-B-2). In some embodiments, the AR device 500 and the VR device 510 can include one or more analogous components (e.g., components for presenting interactive artificial-reality environments, such as processors, memory, and/or presentation devices, including one or more displays and/or one or more waveguides), some of which are described in more detail with respect to FIG. 5C. The head-wearable devices can use display projectors (e.g., display projector assemblies 507A and 507B) and/or waveguides for projecting representations of data to a user. Some embodiments of head-wearable devices do not include displays.

FIG. 5A shows an example visual depiction of the AR device 500 (e.g., which may also be described herein as augmented-reality glasses and/or smart glasses). The AR device 500 can work in conjunction with additional electronic components that are not shown in FIGS. 5A, such as a wearable accessory device and/or an intermediary processing device, in electronic communication or otherwise configured to be used in conjunction with the AR device 500. In some embodiments, the wearable accessory device and/or the intermediary processing device may be configured to couple with the AR device 500 via a coupling mechanism in electronic communication with a coupling sensor 524, where the coupling sensor 524 can detect when an electronic device becomes physically or electronically coupled with the AR device 500. In some embodiments, the AR device 500 can be configured to couple to a housing (e.g., a portion of frame 504 or temple arms 505), which may include one or more additional coupling mechanisms configured to couple with additional accessory devices. The components shown in FIG. 5A can be implemented in hardware, software, firmware, or a combination thereof, including one or more signal-processing components and/or application-specific integrated circuits (ASICs).

The AR device 500 includes mechanical glasses components, including a frame 504 configured to hold one or more lenses (e.g., one or both lenses 506-1 and 506-2). One of ordinary skill in the art will appreciate that the AR device 500 can include additional mechanical components, such as hinges configured to allow portions of the frame 504 of the AR device 500 to be folded and unfolded, a bridge configured to span the gap between the lenses 506-1 and 506-2 and rest on the user's nose, nose pads configured to rest on the bridge of the nose and provide support for the AR device 500, earpieces configured to rest on the user's ears and provide additional support for the AR device 500, temple arms 505 configured to extend from the hinges to the earpieces of the AR device 500, and the like. One of ordinary skill in the art will further appreciate that some examples of the AR device 500 can include none of the mechanical components described herein. For example, smart contact lenses configured to present artificial-reality to users may not include any components of the AR device 500.

The lenses 506-1 and 506-2 can be individual displays or display devices (e.g., a waveguide for projected representations). The lenses 506-1 and 506-2 may act together or independently to present an image or series of images to a user. In some embodiments, the lenses 506-1 and 506-2 can operate in conjunction with one or more display projector assemblies 507A and 507B to present image data to a user. While the AR device 500 includes two displays, embodiments of this disclosure may be implemented in AR devices with a single near-eye display (NED) or more than two NEDs.

The AR device 500 includes electronic components, many of which will be described in more detail below with respect to FIG. 5C. Some example electronic components are illustrated in FIG. 5A, including sensors 523-1, 523-2, 523-3, 523-4, 523-5, and 523-6, which can be distributed along a substantial portion of the frame 504 of the AR device 500. The different types of sensors are described below in reference to FIG. 5C. The AR device 500 also includes a left camera 539A and a right camera 539B, which are located on different sides of the frame 504. And the eyewear device includes one or more processors 548A and 548B (e.g., an integral microprocessor, such as an ASIC) that is embedded into a portion of the frame 504.

FIGS. 5B-1 and 5B-2 show an example visual depiction of the VR device 510 (e.g., a head-mounted display (HMD) 512, also referred to herein as an artificial-reality headset, a head-wearable device, a VR headset, etc.). The HMD 512 includes a front body 514 and a frame 516 (e.g., a strap or band) shaped to fit around a user's head. In some embodiments, the front body 514 and/or the frame 516 includes one or more electronic elements for facilitating presentation of and/or interactions with an AR and/or VR system (e.g., displays, processors (e.g., processor 548A-1), IMUs, tracking emitter or detectors, sensors, etc.). In some embodiments, the HMD 512 includes output audio transducers (e.g., an audio transducer 518-1), as shown in FIG. 5B-2. In some embodiments, one or more components, such as the output audio transducer(s) 518-1 and the frame 516, can be configured to attach and detach (e.g., are detachably attachable) to the HMD 512 (e.g., a portion or all of the frame 516, and/or the output audio transducer 518-1), as shown in FIG. 5B-2. In some embodiments, coupling a detachable component to the HMD 512 causes the detachable component to come into electronic communication with the HMD 512. The VR device 510 includes electronic components, many of which will be described in more detail below with respect to FIG. 5C

FIG. 5B-1 to 5B-2 also show that the VR device 510 one or more cameras, such as the left camera 539A and the right camera 539B, which can be analogous to the left and right cameras on the frame 504 of the AR device 500. In some embodiments, the VR device 510 includes one or more additional cameras (e.g., cameras 539C and 539D), which can be configured to augment image data obtained by the cameras 539A and 539B by providing more information. For example, the camera 539C can be used to supply color information that is not discerned by cameras 539A and 539B. In some embodiments, one or more of the cameras 539A to 539D can include an optional IR cut filter configured to remove IR light from being received at the respective camera sensors.

The VR device 510 can include a housing 590 storing one or more components of the VR device 510 and/or additional components of the VR device 510. The housing 590 can be a modular electronic device configured to couple with the VR device 510 (or an AR device 500) and supplement and/or extend the capabilities of the VR device 510 (or an AR device 500). For example, the housing 590 can include additional sensors, cameras, power sources, processors (e.g., processor 548A-2), etc. to improve and/or increase the functionality of the VR device 510. Examples of the different components included in the housing 590 are described below in reference to FIG. 5C.

Alternatively or in addition, in some embodiments, the head-wearable device, such as the VR device 510 and/or the AR device 500), includes, or is communicatively coupled to, another external device (e.g., a paired device), such as an HIPD 6 (discussed below in reference to FIGS. 6A-6B) and/or an optional neckband. The optional neckband can couple to the head-wearable device via one or more connectors (e.g., wired or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckband may also apply to various other paired devices, such as smart watches, smart phones, wrist bands, other wearable devices, hand-held controllers, tablet computers, or laptop computers.

In some situations, pairing external devices, such as an intermediary processing device (e.g., an HIPD device 600, an optional neckband, and/or wearable accessory device) with the head-wearable devices (e.g., an AR device 500 and/or VR device 510) enables the head-wearable devices to achieve a similar form factor of a pair of glasses while still providing sufficient battery and computation power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable devices overall while allowing the head-wearable devices to retain its desired functionality. For example, the intermediary processing device (e.g., the HIPD 600) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, storage, etc.) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, like an HIPD 600, can process information generated by one or more sensors of its sensors and/or information provided by other communicatively coupled devices. For example, a head-wearable device can include an IMU, and the intermediary processing device (neckband and/or an HIPD 600) can compute all inertial and spatial calculations from the IMUs located on the head-wearable device. Additional examples of processing performed by a communicatively coupled device, such as the HIPD 600, are provided below in reference to FIGS. 6A and 6B.

Artificial-reality systems may include a variety of types of visual feedback mechanisms. For example, display devices in the AR devices 500 and/or the VR devices 510 may include one or more liquid-crystal displays (LCDs), light emitting diode (LED) displays, organic LED (OLED) displays, and/or any other suitable type of display screen. Artificial-reality systems may include a single display screen for both eyes or may provide a display screen for each eye, which may allow for additional flexibility for varifocal adjustments or for correcting a refractive error associated with the user's vision. Some artificial-reality systems also include optical subsystems having one or more lenses (e.g., conventional concave or convex lenses, Fresnel lenses, or adjustable liquid lenses) through which a user may view a display screen. In addition to or instead of using display screens, some artificial-reality systems include one or more projection systems. For example, display devices in the AR device 500 and/or the VR device 510 may include micro-LED projectors that project light (e.g., using a waveguide) into display devices, such as clear combiner lenses that allow ambient light to pass through. The display devices may refract the projected light toward a user's pupil and may enable a user to simultaneously view both artificial-reality content and the real world. Artificial-reality systems may also be configured with any other suitable type or form of image projection system. As noted, some AR systems may, instead of blending an artificial reality with actual reality, substantially replace one or more of a user's sensory perceptions of the real world with a virtual experience.

While the example head-wearable devices are respectively described herein as the AR device 500 and the VR device 510, either or both of the example head-wearable devices described herein can be configured to present fully-immersive VR scenes presented in substantially all of a user's field of view, additionally or alternatively to, subtler augmented-reality scenes that are presented within a portion, less than all, of the user's field of view.

In some embodiments, the AR device 500 and/or the VR device 510 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices (e.g., wrist-wearable devices which may be incorporated into headwear, gloves, body suits, handheld controllers, environmental devices (e.g., chairs or floormats), and/or any other type of device or system, such as a wrist-wearable device 400, an HIPD 600, smart textile-based garment 700, etc.), and/or other devices described herein.

FIG. 5C illustrates a computing system 520 and an optional housing 590, each of which show components that can be included in a head-wearable device (e.g., the AR device 500 and/or the VR device 510). In some embodiments, more or less components can be included in the optional housing 590 depending on practical restraints of the respective head-wearable device being described. Additionally or alternatively, the optional housing 590 can include additional components to expand and/or augment the functionality of a head-wearable device.

In some embodiments, the computing system 520 and/or the optional housing 590 can include one or more peripheral interfaces 522A and 522B, one or more power systems 542A and 542B (including charger input 543, PMIC 544, and battery 545), one or more controllers 546A 546B (including one or more haptic controllers 547), one or more processors 548A and 548B (as defined above, including any of the examples provided), and memory 550A and 550B, which can all be in electronic communication with each other. For example, the one or more processors 548A and/or 548B can be configured to execute instructions stored in the memory 550A and/or 550B, which can cause a controller of the one or more controllers 546A and/or 546B to cause operations to be performed at one or more peripheral devices of the peripherals interfaces 522A and/or 522B. In some embodiments, each operation described can occur based on electrical power provided by the power system 542A and/or 542B.

In some embodiments, the peripherals interface 522A can include one or more devices configured to be part of the computing system 520, many of which have been defined above and/or described with respect to wrist-wearable devices shown in FIGS. 4A and 4B. For example, the peripherals interface can include one or more sensors 523A. Some example sensors include: one or more coupling sensors 524, one or more acoustic sensors 525, one or more imaging sensors 526, one or more EMG sensors 527, one or more capacitive sensors 528, and/or one or more IMUs 529. In some embodiments, the sensors 523A further include depth sensors 567, light sensors 568 and/or any other types of sensors defined above or described with respect to any other embodiments discussed herein.

In some embodiments, the peripherals interface can include one or more additional peripheral devices, including one or more NFC devices 530, one or more GPS devices 531, one or more LTE devices 532, one or more WiFi and/or Bluetooth devices 533, one or more buttons 534 (e.g., including buttons that are slidable or otherwise adjustable), one or more displays 535A, one or more speakers 536A, one or more microphones 537A, one or more cameras 538A (e.g., including the a first camera 539-1 through nth camera 539-n, which are analogous to the left camera 539A and/or the right camera 539B), one or more haptic devices 540; and/or any other types of peripheral devices defined above or described with respect to any other embodiments discussed herein.

The head-wearable devices can include a variety of types of visual feedback mechanisms (e.g., presentation devices). For example, display devices in the AR device 500 and/or the VR device 510 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes), and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 535A can be coupled to each of the lenses 506-1 and 506-2 of the AR device 500. The displays 535A coupled to each of the lenses 506-1 and 506-2 can act together or independently to present an image or series of images to a user. In some embodiments, the AR device 500 and/or the VR device 510 includes a single display 535A (e.g., a near-eye display) or more than two displays 535A.

In some embodiments, a first set of one or more displays 535A can be used to present an augmented-reality environment, and a second set of one or more display devices 535A can be used to present a virtual-reality environment. In some embodiments, one or more waveguides are used in conjunction with presenting artificial-reality content to the user of the AR device 500 and/or the VR device 510 (e.g., as a means of delivering light from a display projector assembly and/or one or more displays 535A to the user's eyes). In some embodiments, one or more waveguides are fully or partially integrated into the AR device 500 and/or the VR device 510. Additionally, or alternatively to display screens, some artificial-reality systems include one or more projection systems. For example, display devices in the AR device 500 and/or the VR device 510 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. The head-wearable devices can also be configured with any other suitable type or form of image projection system. In some embodiments, one or more waveguides are provided additionally or alternatively to the one or more display(s) 535A.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15-50% of the ambient light and/or the real-world live view) can be passed through the user interface element, such that the user can distinguish at least a portion of the physical environment over which the user interface element is being displayed.

The head-wearable devices can include one or more external displays 535A for presenting information to users. For example, an external display 535A can be used to show a current battery level, network activity (e.g., connected, disconnected, etc.), current activity (e.g., playing a game, in a call, in a meeting, watching a movie, etc.), and/or other relevant information. In some embodiments, the external displays 535A can be used to communicate with others. For example, a user of the head-wearable device can cause the external displays 535A to present a do not disturb notification. The external displays 535A can also be used by the user to share any information captured by the one or more components of the peripherals interface 522A and/or generated by head-wearable device (e.g., during operation and/or performance of one or more applications).

The memory 550A can include instructions and/or data executable by one or more processors 548A (and/or processors 548B of the housing 590) and/or a memory controller of the one or more controllers 546A (and/or controller 546B of the housing 590). The memory 550A can include one or more operating systems 551; one or more applications 552; one or more communication interface modules 553A; one or more graphics modules 554A; one or more AR processing modules 555A; device coordination module 556A for allowing presented information to seamless switch between a plurality of devices; and/or any other types of modules or components defined above or described with respect to any other embodiments discussed herein.

The data 560 stored in memory 550A can be used in conjunction with one or more of the applications and/or programs discussed above. The data 560 can include profile data 561; sensor data 562; media content data 563; AR application data 564; device coordination data 565 for allowing presented information to seamless switch between a plurality of devices; and/or any other types of data defined above or described with respect to any other embodiments discussed herein.

In some embodiments, the controller 546A of the head-wearable devices processes information generated by the sensors 523A on the head-wearable devices and/or another component of the head-wearable devices and/or communicatively coupled with the head-wearable devices (e.g., components of the housing 590, such as components of peripherals interface 522B). For example, the controller 546A can process information from the acoustic sensors 525 and/or image sensors 526. For each detected sound, the controller 546A can perform a direction of arrival (DOA) estimation to estimate a direction from which the detected sound arrived at a head-wearable device. As one or more of the acoustic sensors 525 detects sounds, the controller 546A can populate an audio data set with the information (e.g., represented by sensor data 562).

In some embodiments, a physical electronic connector can convey information between the head-wearable devices and another electronic device, and/or between one or more processors 548A of the head-wearable devices and the controller 546A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 600) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 500 and/or the VR device 510 can include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. A head-wearable device can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with in AR environment), among a variety of other functions. For example, FIGS. 5B-1 and 5B-2 show the VR device 510 having cameras 539A-539D, which can be used to provide depth information for creating a voxel field and a two-dimensional mesh to provide object information to the user to avoid collisions.

The optional housing 590 can include analogous components to those describe above with respect to the computing system 520. For example, the optional housing 590 can include a respective peripherals interface 522B including more or less components to those described above with respect to the peripherals interface 522A. As described above, the components of the optional housing 590 can be used augment and/or expand on the functionality of the head-wearable devices. For example, the optional housing 590 can include respective sensors 523B, speakers 536B, displays 535B, microphones 537B, cameras 538B, and/or other components to capture and/or present data. Similarly, the optional housing 590 can include one or more processors 548B, controllers 546B, and/or memory 550B (including respective communication interface modules 553B; one or more graphics modules 554B; one or more AR processing modules 555B, etc.) that can be used individually and/or in conjunction with the components of the computing system 520.

The techniques described above in FIGS. 5A-5C can be used with different head-wearable devices. In some embodiments, the head-wearable devices (e.g., the AR device 500 and/or the VR device 510) can be used in conjunction with one or more wearable device such as a wrist-wearable device 400 (or components thereof) and/or an HIPD 600. Having thus described example the head-wearable devices, attention will now be turned to example handheld intermediary processing devices, such as HIPD 600.

### Example Handheld Intermediary Processing Devices

FIGS. 6A and 6B illustrate an example handheld intermediary processing device (HIPD) 600, in accordance with some embodiments. The HIPD 600 is an instance of the intermediary device described in reference to FIGS. 1A-2E herein, such that the HIPD 600 should be understood to have the features described with respect to any intermediary device defined above or otherwise described herein, and vice versa. The HIPD 600 can perform various functions and/or operations associated with navigating through user interfaces and selectively opening applications, as well as the functions and/or operations described above with reference to FIGS. 1A-2E.

FIG. 6A shows a top view 605 and a side view 625 of the HIPD 600. The HIPD 600 is configured to communicatively couple with one or more wearable devices (or other electronic devices) associated with a user. For example, the HIPD 600 is configured to communicatively couple with a user's wrist-wearable device 400 (or components thereof, such as the watch body 420 and the wearable band 410), AR device 500, and/or VR device 510. The HIPD 600 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which the HIPD 600 can successfully be communicatively coupled with an electronic device, such as a wearable device).

The HIPD 600 can perform various functions independently and/or in conjunction with one or more wearable devices (e.g., wrist-wearable device 400, AR device 500, VR device 510, etc.). The HIPD 600 is configured to increase and/or improve the functionality of communicatively coupled devices, such as the wearable devices. The HIPD 600 is configured to perform one or more functions or operations associated with interacting with user interfaces and applications of communicatively coupled devices, interacting with an AR environment, interacting with VR environment, and/or operating as a human-machine interface controller, as well as functions and/or operations described above with reference to FIGS. 1A-2E. Additionally, as will be described in more detail below, functionality and/or operations of the HIPD 600 can include, without limitation, task offloading and/or handoffs; thermals offloading and/or handoffs; 6 degrees of freedom (6DoF) raycasting and/or gaming (e.g., using imaging devices or cameras 614A and 614B, which can be used for simultaneous localization and mapping (SLAM) and/or with other image processing techniques); portable charging; messaging; image capturing via one or more imaging devices or cameras (e.g., cameras 622A and 622B); sensing user input (e.g., sensing a touch on a multi-touch input surface 602); wireless communications and/or interlining (e.g., cellular, near field, Wi-Fi, personal area network, etc.); location determination; financial transactions; providing haptic feedback; alarms; notifications; biometric authentication; health monitoring; sleep monitoring; etc. The above-example functions can be executed independently in the HIPD 600 and/or in communication between the HIPD 600 and another wearable device described herein. In some embodiments, functions can be executed on the HIPD 600 in conjunction with an AR environment. As the skilled artisan will appreciate upon reading the descriptions provided herein, the novel the HIPD 600 described herein can be used with any type of suitable AR environment.

While the HIPD 600 is communicatively coupled with a wearable device and/or other electronic device, the HIPD 600 is configured to perform one or more operations initiated at the wearable device and/or the other electronic device. In particular, one or more operations of the wearable device and/or the other electronic device can be offloaded to the HIPD 600 to be performed. The HIPD 600 performs the one or more operations of the wearable device and/or the other electronic device and provides to data corresponded to the completed operations to the wearable device and/or the other electronic device. For example, a user can initiate a video stream using AR device 500 and back-end tasks associated with performing the video stream (e.g., video rendering) can be offloaded to the HIPD 600, which the HIPD 600 performs and provides corresponding data to the AR device 500 to perform remaining front-end tasks associated with the video stream (e.g., presenting the rendered video data via a display of the AR device 500). In this way, the HIPD 600, which has more computational resources and greater thermal headroom than a wearable device, can perform computationally intensive tasks for the wearable device improving performance of an operation performed by the wearable device.

The HIPD 600 includes a multi-touch input surface 602 on a first side (e.g., a front surface) that is configured to detect one or more user inputs. In particular, the multi-touch input surface 602 can detect single tap inputs, multi-tap inputs, swipe gestures and/or inputs, force-based and/or pressure-based touch inputs, held taps, and the like. The multi-touch input surface 602 is configured to detect capacitive touch inputs and/or force (and/or pressure) touch inputs. The multi-touch input surface 602 includes a first touch-input surface 604 defined by a surface depression, and a second touch-input surface 606 defined by a substantially planar portion. The first touch-input surface 604 can be disposed adjacent to the second touch-input surface 606. In some embodiments, the first touch-input surface 604 and the second touch-input surface 606 can be different dimensions, shapes, and/or cover different portions of the multi-touch input surface 602. For example, the first touch-input surface 604 can be substantially circular and the second touch-input surface 606 is substantially rectangular. In some embodiments, the surface depression of the multi-touch input surface 602 is configured to guide user handling of the HIPD 600. In particular, the surface depression is configured such that the user holds the HIPD 600 upright when held in a single hand (e.g., such that the using imaging devices or cameras 614A and 614B are pointed toward a ceiling or the sky). Additionally, the surface depression is configured such that the user's thumb rests within the first touch-input surface 604.

In some embodiments, the different touch-input surfaces include a plurality of touch-input zones. For example, the second touch-input surface 606 includes at least a first touch-input zone 608 within a second touch-input zone 606 and a third touch-input zone 610 within the first touch-input zone 608. In some embodiments, one or more of the touch-input zones are optional and/or user defined (e.g., a user can specific a touch-input zone based on their preferences). In some embodiments, each touch-input surface and/or touch-input zone is associated with a predetermined set of commands. For example, a user input detected within the first touch-input zone 608 causes the HIPD 600 to perform a first command and a user input detected within the second touch-input zone 606 causes the HIPD 600 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, the first touch-input zone 608 can be configured to detect force touch inputs (e.g., a magnitude at which the user presses down) and capacitive touch inputs, and the second touch-input zone 606 can be configured to detect capacitive touch inputs.

The HIPD 600 includes one or more sensors 651 for sensing data used in the performance of one or more operations and/or functions. For example, the HIPD 600 can include an IMU that is used in conjunction with cameras 614 for 3-dimensional object manipulation (e.g., enlarging, moving, destroying, etc. an object) in an AR or VR environment. Non-limiting examples of the sensors 651 included in the HIPD 600 include a light sensor, a magnetometer, a depth sensor, a pressure sensor, and a force sensor. Additional examples of the sensors 651 are provided below in reference to FIG. 6B.

The HIPD 600 can include one or more light indicators 612 to provide one or more notifications to the user. In some embodiments, the light indicators are LEDs or other types of illumination devices. The light indicators 612 can operate as a privacy light to notify the user and/or others near the user that an imaging device and/or microphone are active. In some embodiments, a light indicator is positioned adjacent to one or more touch-input surfaces. For example, a light indicator can be positioned around the first touch-input surface 604. The light indicators can be illuminated in different colors and/or patterns to provide the user with one or more notifications and/or information about the device. For example, a light indicator positioned around the first touch-input surface 604 can flash when the user receives a notification (e.g., a message), change red when the HIPD 600 is out of power, operate as a progress bar (e.g., a light ring that is closed when a task is completed (e.g., 0% to 100%)), operates as a volume indicator, etc.).

In some embodiments, the HIPD 600 includes one or more additional sensors on another surface. For example, as shown FIG. 6A, HIPD 600 includes a set of one or more sensors (e.g., sensor set 620) on an edge of the HIPD 600. The sensor set 620, when positioned on an edge of the of the HIPD 600, can be pe positioned at a predetermined tilt angle (e.g., 26 degrees), which allows the sensor set 620 to be angled toward the user when placed on a desk or other flat surface. Alternatively, in some embodiments, the sensor set 620 is positioned on a surface opposite the multi-touch input surface 602 (e.g., a back surface). The one or more sensors of the sensor set 620 are discussed in detail below.

The side view 625 of the of the HIPD 600 shows the sensor set 620 and camera 614B. The sensor set 620 includes one or more cameras 622A and 622B, a depth projector 624, an ambient light sensor 628, and a depth receiver 630. In some embodiments, the sensor set 620 includes a light indicator 626. The light indicator 626 can operate as a privacy indicator to let the user and/or those around them know that a camera and/or microphone is active. The sensor set 620 is configured to capture a user's facial expression such that the user can puppet a custom avatar (e.g., showing emotions, such as smiles, laughter, etc., on the avatar or a digital representation of the user). The sensor set 620 can be configured as a side stereo RGB system, a rear indirect Time-of-Flight (iToF) system, or a rear stereo RGB system. As the skilled artisan will appreciate upon reading the descriptions provided herein, the novel HIPD 600 described herein can use different sensor set 620 configurations and/or sensor set 620 placement.

In some embodiments, the HIPD 600 includes one or more haptic devices 671 (FIG. 6B; e.g., a vibratory haptic actuator) that are configured to provide haptic feedback (e.g., kinesthetic sensation). The sensors 651, and/or the haptic devices 671 can be configured to operate in conjunction with multiple applications and/or communicatively coupled devices including, without limitation, a wearable devices, health monitoring applications, social media applications, game applications, and artificial reality applications (e.g., the applications associated with artificial reality).

The HIPD 600 is configured to operate without a display. However, in optional embodiments, the HIPD 600 can include a display 668 (FIG. 6B). The HIPD 600 can also income one or more optional peripheral buttons 667 (FIG. 6B). For example, the peripheral buttons 667 can be used to turn on or turn off the HIPD 600. Further, the HIPD 600 housing can be formed of polymers and/or elastomer elastomers. The HIPD 600 can be configured to have a non-slip surface to allow the HIPD 600 to be placed on a surface without requiring a user to watch over the HIPD 600. In other words, the HIPD 600 is designed such that it would not easily slide off surfaces. In some embodiments, the HIPD 600 include one or magnets to couple the HIPD 600 to another surface. This allows the user to mount the HIPD 600 to different surfaces and provide the user with greater flexibility in use of the HIPD 600.

As described above, the HIPD 600 can distribute and/or provide instructions for performing the one or more tasks at the HIPD 600 and/or a communicatively coupled device. For example, the HIPD 600 can identify one or more back-end tasks to be performed by the HIPD 600 and one or more front-end tasks to be performed by a communicatively coupled device. While the HIPD 600 is configured to offload and/or handoff tasks of a communicatively coupled device, the HIPD 600 can perform both back-end and front-end tasks (e.g., via one or more processors, such as CPU 677; FIG. 6B). The HIPD 600 can, without limitation, can be used to perform augmenting calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. The HIPD 600 can perform the above operations alone or in conjunction with a wearable device (or other communicatively coupled electronic device).

FIG. 6B shows block diagrams of a computing system 640 of the HIPD 600, in accordance with some embodiments. The HIPD 600, described in detail above, can include one or more components shown in HIPD computing system 640. The HIPD 600 will be understood to include the components shown and described below for the HIPD computing system 640. In some embodiments, all, or a substantial portion of the components of the HIPD computing system 640 are included in a single integrated circuit. Alternatively, in some embodiments, components of the HIPD computing system 640 are included in a plurality of integrated circuits that are communicatively coupled.

The HIPD computing system 640 can include a processor (e.g., a CPU 677, a GPU, and/or a CPU with integrated graphics), a controller 675, a peripherals interface 650 that includes one or more sensors 651 and other peripheral devices, a power source (e.g., a power system 695), and memory (e.g., a memory 678) that includes an operating system (e.g., an operating system 679), data (e.g., data 688), one or more applications (e.g., applications 680), and one or more modules (e.g., a communications interface module 681, a graphics module 682, a task and processing management module 683, an interoperability module 684, an AR processing module 685, a data management module 686, a device coordination module 687, etc.). The HIPD computing system 640 further includes a power system 695 that includes a charger input and output 696, a PMIC 697, and a battery 698, all of which are defined above.

In some embodiments, the peripherals interface 650 can include one or more sensors 651. The sensors 651 can include analogous sensors to those described above in reference to FIGS. 4B. For example, the sensors 651 can include imaging sensors 654, (optional) EMG sensors 656, IMUs 658, and capacitive sensors 660. In some embodiments, the sensors 651 can include one or more pressure sensor 652 for sensing pressure data, an altimeter 653 for sensing an altitude of the HIPD 600, a magnetometer 655 for sensing a magnetic field, a depth sensor 657 (or a time-of flight sensor) for determining a difference between the camera and the subject of an image, a position sensor 659 (e.g., a flexible position sensor) for sensing a relative displacement or position change of a portion of the HIPD 600, a force sensor 661 for sensing a force applied to a portion of the HIPD 600, and a light sensor 662 (e.g., an ambient light sensor) for detecting an amount of lighting. The sensors 651 can include one or more sensors not shown in FIG. 6B.

Analogous to the peripherals described above in reference to FIGS. 4B, the peripherals interface 650 can also include an NFC component 663, a GPS component 664, an LTE component 665, a Wi-Fi and/or Bluetooth communication component 666, a speaker 669, a haptic device 671, and a microphone 673. As described above in reference to FIG. 6A, the HIPD 600 can optionally include a display 668 and/or one or more buttons 667. The peripherals interface 650 can further include one or more cameras 670, touch surfaces 672, and/or one or more light emitters 674. The multi-touch input surface 602 described above in reference to FIG. 6A is an example of touch surface 672. The light emitters 674 can be one or more LEDs, lasers, etc. and can be used to project or present information to a user. For example, the light emitters 674 can include light indicators 612 and 626 described above in reference to FIG. 6A. The cameras 670 (e.g., cameras 614A, 614B, and 622 described above in FIG. 6A) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other available cameras. Cameras 670 can be used for SLAM; 6 DoF ray casting, gaming, object manipulation, and/or other rendering; facial recognition and facial expression recognition, etc.

Similar to the watch body computing system 460 and the watch band computing system 430 described above in reference to FIG. 4B, the HIPD computing system 640 can include one or more haptic controllers 676 and associated componentry (e.g., haptic devices 671) for providing haptic events at the HIPD 600.

Memory 678 can include high-speed random-access memory and/or non-volatile memory, such as one or more magnetic disk storage devices, flash memory devices, or other non-volatile solid-state memory devices. Access to the memory 678 by other components of the HIPD 600, such as the one or more processors and the peripherals interface 650, can be controlled by a memory controller of the controllers 675.

In some embodiments, software components stored in the memory 678 include one or more operating systems 679, one or more applications 680, one or more communication interface modules 681, one or more graphics modules 682, one or more data management modules 685, which are analogous to the software components described above in reference to FIG. 4B. The software components stored in the memory 678 can also include a device coordination module 686A which is configured to perform the features described above in reference to FIGS. 1A-2E.

In some embodiments, software components stored in the memory 678 include a task and processing management module 683 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 683 uses data 688 (e.g., device data 690) to distribute the one or more front-end and/or back-end tasks based on communicatively coupled devices' computing resources, available power, thermal headroom, ongoing operations, and/or other factors. For example, the task and processing management module 683 can cause the performance of one or more back-end tasks (of an operation performed at communicatively coupled AR device 500) at the HIPD 600 in accordance with a determination that the operation is utilizing a predetermined amount (e.g., at least 70%) of computing resources available at the AR device 500.

In some embodiments, software components stored in the memory 678 include an interoperability module 684 for exchanging and utilizing information received and/or provided to distinct communicatively coupled devices. The interoperability module 684 allows for different systems, devices, and/or applications to connect and communicate in a coordinated way without user input. In some embodiments, software components stored in the memory 678 include an AR module 685 that is configured to process signals based at least on sensor data for use in an AR and/or VR environment. For example, the AR processing module 685 can be used for 3D object manipulation, gesture recognition, facial and facial expression, recognition, etc.

The memory 678 can also include data 687, including structured data. In some embodiments, the data 687 can include profile data 689, device data 689 (including device data of one or more devices communicatively coupled with the HIPD 600, such as device type, hardware, software, configurations, etc.), sensor data 691, media content data 692, application data 693, and device coordination data 694, which stores data related to the performance of the features described above in reference to FIGS. 1A-2E.

It should be appreciated that the HIPD computing system 640 is an example of a computing system within the HIPD 600, and that the HIPD 600 can have more or fewer components than shown in the HIPD computing system 640, combine two or more components, and/or have a different configuration and/or arrangement of the components. The various components shown in HIPD computing system 640 are implemented in hardware, software, firmware, or a combination thereof, including one or more signal processing and/or application-specific integrated circuits.

The techniques described above in FIG. 6A-6B can be used with any device used as a human-machine interface controller. In some embodiments, an HIPD 600 can be used in conjunction with one or more wearable device such as a head-wearable device (e.g., AR device 500 and VR device 510) and/or a wrist-wearable device 400 (or components thereof).

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory computer readable storage medium including executable instructions that, when executed by a computing device, cause the computing device to:
while a head-wearable device, worn by a user, is communicatively coupled to one or more display devices:
cause the head-wearable device to display a user interface;
in accordance with a determination, at a first point in time, that the user is looking at a first display device of the one or more display devices:
cause the head-wearable device to cease displaying the user interface; and
cause the first display device to display the user interface; and
in accordance with a determination, at a second point in time after the first point in time, that the user is not looking at the one or more displays devices:
cause the first display device to cease displaying the user interface; and
cause the head-wearable device to display the user interface.

2. The non-transitory computer readable storage medium of claim 1, wherein:
causing the head-wearable device to cease displaying the user interface and causing the first display device to display the user interface are further in accordance with a determination that the user performs a select input; and
causing the first display device to cease displaying the user interface and causing the head-wearable device to display the user interface are further in accordance with a determination that the user performs another select input.

3. The non-transitory computer readable storage medium of claim 1, wherein:
the determination that the user is looking at the first display device of the one or more display devices includes determining that the user is looking at the first display device for a first predetermined period of time; and
the determination that the user is not looking at the one or more displays devices includes determining that the user is has not looked at any of the one or more display devices for a second predetermined period of time.

4. The non-transitory computer readable storage medium of claim 1, wherein causing the head-wearable device to cease displaying the user interface and causing the first display device to display the user interface are further in accordance with a determination that the first display device is of display type that can display the user interface.

5. The non-transitory computer readable storage medium of claim 1, wherein the executable instructions further cause the computing device to:
while the head-wearable device, worn by the user, is communicatively coupled to the one or more display devices:
in accordance with a determination, at a third point in time after the first point in time and before the second point in time, that the user is looking at a second display device of the one or more display devices:
cause the first display device to cease displaying the user interface; and
cause the second display device to display the user interface; and
in accordance with a determination, at a fourth point in time after the third point in time, that the user is not looking at the one or more displays devices:
cause the second display device to cease displaying the user interface; and
cause the head-wearable device to display the user interface.

6. The non-transitory computer readable storage medium of claim 1, wherein the executable instructions further cause the computing device to:
while the head-wearable device, worn by the user, is communicatively coupled to the one or more display devices:
in accordance with a determination, at a fifth point in time after the second point in time, that the user is looking at a third display device of the one or more display devices:
cause the head-wearable device to cease displaying the user interface; and
cause the third display device to display the user interface; and
in accordance with a determination, at a sixth point in time after the fifth point in time, that the user is not looking at the one or more displays devices:
cause the third display device to cease displaying the user interface; and
cause the head-wearable device to display the user interface.

7. The non-transitory computer readable storage medium of claim 1, wherein the executable instructions further cause the computing device to:
while the head-wearable device, worn by the user, is communicatively coupled to the one or more display devices:
in response to a switch input, performed by the user and indicating a fourth display device of the one or more display devices:
cause the first display device to cease displaying the user interface; and
cause the fourth display device to display the user interface.

8. The non-transitory computer readable storage medium of claim 7, wherein the executable instructions further cause the computing device to:
while the head-wearable device, worn by the user, is communicatively coupled to the one or more display devices:
in response to another switch input, indicating a fourth display device of the one or more display devices:
cause the third display device to cease displaying the user interface; and
cause the fourth display device to display the user interface.

9. The non-transitory computer readable storage medium of claim 7, wherein the executable instructions further cause the computing device to:
while the head-wearable device, worn by the user, is communicatively coupled to the one or more display devices:
in response to the switch input, indicating a fourth display device of the one or more display devices, and before causing the first display device to cease displaying the user interface and causing the fourth display device to display the user interface:
cause the first display device to display a first portion of the user interface; and
cause the fourth display device to display a second portion of the user interface, wherein the user interface appears to slide from the first display device to the fourth display device.

10. The non-transitory computer readable storage medium of claim 7, wherein the switch input is at least one of a hand gesture, a voice command, and a button press.

11. The non-transitory computer readable storage medium of claim 1, wherein the determination that the user is looking at a first display device of the one or more display devices and the determination that the user is not looking at the one or more displays devices is based on at least one of a gaze location of the user, a head position of the user, a body position of the user, and image data captured at a forward-facing camera of the head-wearable device.

12. The non-transitory computer readable storage medium of claim 1, wherein the one or more display devices include at least one of a smartphone, a display monitor, a personal computer, a television set, a smart watch, and a tablet.

13. A head-wearable device, including:
one or more displays;
one or more cameras; and
one or more storage devices, storing executable instructions that, when executed by one or more processors and while the head-wearable device, worn by a user, is communicatively coupled to one or more display devices, cause the head-wearable device to:
cause the head-wearable device to display a user interface;
in accordance with a determination, at a first point in time, that the user is looking at a first display device of the one or more display devices:
cause the head-wearable device to cease displaying the user interface; and
cause the first display device to display the user interface; and
in accordance with a determination, at a second point in time after the first point in time, that the user is not looking at the one or more displays devices:
cause the first display device to cease displaying the user interface; and
cause the head-wearable device to display the user interface.

14. The head-wearable device of claim 13, wherein causing the head-wearable device to cease displaying the user interface and causing the first display device to display the user interface are further in accordance with a determination that the first display device is of display type that can display the user interface.

15. The head-wearable device of claim 13, wherein the executable instructions further cause the head-wearable device to:
in accordance with a determination, at a third point in time after the first point in time and before the second point in time, that the user is looking at a second display device of the one or more display devices:
cause the first display device to cease displaying the user interface; and
cause the second display device to display the user interface; and
in accordance with a determination, at a fourth point in time after the third point in time, that the user is not looking at the one or more displays devices:
cause the second display device to cease displaying the user interface; and
cause the head-wearable device to display the user interface.

16. The head-wearable device of claim 13, wherein the executable instructions further cause the head-wearable device to:
in accordance with a determination, at a fifth point in time after the second point in time, that the user is looking at a third display device of the one or more display devices:
cause the head-wearable device to cease displaying the user interface; and
cause the third display device to display the user interface; and
in accordance with a determination, at a sixth point in time after the fifth point in time, that the user is not looking at the one or more displays devices:
cause the third display device to cease displaying the user interface; and
cause the head-wearable device to display the user interface.

17. A method comprising:
while a head-wearable device, worn by a user, is communicatively coupled to one or more display devices:
causing the head-wearable device to display a user interface;
in accordance with a determination, at a first point in time, that the user is looking at a first display device of the one or more display devices:
causing the head-wearable device to cease displaying the user interface; and
causing the first display device to display the user interface; and
in accordance with a determination, at a second point in time after the first point in time, that the user is not looking at the one or more displays devices:
causing the first display device to cease displaying the user interface; and
causing the head-wearable device to display the user interface.

18. The method of claim 17, wherein causing the head-wearable device to cease displaying the user interface and causing the first display device to display the user interface are further in accordance with a determination that the first display device is of display type that can display the user interface.

19. The method of claim 17, further comprising:
while the head-wearable device, worn by the user, is communicatively coupled to the one or more display devices:
in accordance with a determination, at a third point in time after the first point in time and before the second point in time, that the user is looking at a second display device of the one or more display devices:
causing the first display device to cease displaying the user interface; and
causing the second display device to display the user interface; and
in accordance with a determination, at a fourth point in time after the third point in time, that the user is not looking at the one or more displays devices:
causing the second display device to cease displaying the user interface; and
causing the head-wearable device to display the user interface.

20. The method of claim 17, further comprising:
while the head-wearable device, worn by the user, is communicatively coupled to the one or more display devices:
in accordance with a determination, at a fifth point in time after the second point in time, that the user is looking at a third display device of the one or more display devices:
causing the head-wearable device to cease displaying the user interface; and
causing the third display device to display the user interface; and
in accordance with a determination, at a sixth point in time after the fifth point in time, that the user is not looking at the one or more displays devices:
causing the third display device to cease displaying the user interface; and
causing the head-wearable device to display the user interface.
